(19) United States
(12) Patent Application Publication
(10) Pub. No.: US 2026/0039875 A1
(43) Pub. Date: Feb. 5, 2026

(54) VIDEO DECODING METHOD AND DEVICE THEREFOR, AND VIDEO ENCODING METHOD AND DEVICE THEREFOR

(71) Applicant: SAMSUNG ELECTRONICS CO., LTD., Suwon-si (KR)

(72) Inventors: Minsoo PARK, Suwon-si (KR); Minwoo PARK, Suwon-si (KR); Kwangpyo CHOI, Suwon-si (KR)

(73) Assignee: SAMSUNG ELECTRONICS CO., LTD., Suwon-si (KR)

(21) Appl. No.: 19/355,709

(22) Filed: Oct. 10, 2025

Related U.S. Application Data
(63) Continuation of application No. PCT/KR2024/000671, filed on Jan. 15, 2024.

(30) Foreign Application Priority Data
Apr. 12, 2023 (KR) 10-2023-0048288
Aug. 11, 2023 (KR) 10-2023-0105669

(51) Int. Cl. H04N 19/61; H04N 19/105; H04N 19/176; H04N 19/18; H04N 19/30; H04N 19/70

(52) U.S. Cl. CPC H04N 19/61; H04N 19/105; H04N 19/176; H04N 19/18; H04N 19/30; H04N 19/70

(57) ABSTRACT

Provided are an image decoding method and an image decoding apparatus, and an image encoding method and an image encoding apparatus which correspond thereto, the image decoding method including: selecting a current block from among a plurality of blocks obtained by dividing a current image; determining a plurality of transform blocks including a first transform block and a second transform block based on the current block; scaling a first direct current (DC) transform coefficient value of the first transform block using a size of the first transform block and a reference transform size to obtain a scaled first DC transform coefficient value; obtaining a prediction transform coefficient value for the second transform block based on a size of the second transform block and the scaled first DC transform coefficient value; determining a second DC transform coefficient value of the second transform block based on the prediction transform coefficient value; and restoring the current block by performing an inverse transform on the second transform block based on the second DC transform coefficient value

### CROSS-REFERENCE TO RELATED APPLICATION(S)

This application is a continuation of International Application No. PCT/KR2024/000671, filed on Jan. 15, 2024, in the Korean Intellectual Property Receiving Office, which is based on and claims priority to Korean Patent Application No. 10-2023-0048288 filed on Apr. 12, 2023, and Korean Patent Application No. 10-2023-0105669 filed on Aug. 11, 2023, in the Korean Intellectual Property Office, the disclosures of which are incorporated by reference herein in their entireties.

### BACKGROUND

### Technical Field

### 1. Field

The present disclosure relates to video encoding and decoding, and more particularly to a video encoding and decoding method and apparatus for reducing errors between original images and restored images.

### 2. Description of Related Art

With the development and distribution of hardware capable of reproducing and storing high-resolution or high-quality video content, the need for a video codec that effectively encodes or decodes high-resolution or high-quality video content has increased. According to existing video codecs, video may be encoded according to a limited encoding method based on blocks each having a predetermined size.

Image data in the spatial domain may be converted into coefficients in the frequency domain using frequency transform. Video codecs may divide images into blocks each having a predetermined size to perform fast operation of frequency transform, and may perform a discrete cosine transform (DCT) for each block to encode frequency coefficients in block units. Compared to image data in the spatial domain, coefficients in the frequency domain have a form that is easy to compress. Video codecs reduce the amount of data by replacing data, which continuously and repeatedly occurs, with data having a small size.

### SUMMARY

In accordance with an aspect of the disclosure, an image decoding method includes: selecting a current block from among a plurality of blocks obtained by dividing a current image; determining a plurality of transform blocks including a first transform block and a second transform block based on the current block; scaling a first direct current (DC) transform coefficient value of the first transform block using a size of the first transform block and a reference transform size to obtain a scaled first DC transform coefficient value; obtaining a prediction transform coefficient value for the second transform block based on a size of the second transform block and the scaled first DC transform coefficient value; determining a second DC transform coefficient value of the second transform block based on the prediction transform coefficient value; and restoring the current block by performing an inverse transform on the second transform block based on the second DC transform coefficient value.

In accordance with an aspect of the disclosure, an image decoding apparatus includes: at least one processor; and a memory storing one or more instructions which, when executed by the at least one processor, cause the image decoding apparatus to: select a current block from among a plurality of blocks obtained by dividing a current image, determine a plurality of transform blocks including a first transform block and a second transform block based on the current block, scale a first direct current (DC) transform coefficient value of the first transform block using a size of the first transform block and a reference transform size to obtain a scaled first DC transform coefficient value, obtain a prediction transform coefficient value for the second transform block based on a size of the second transform block and the scaled first DC transform coefficient value, determine a second DC transform coefficient value of the second transform block based on the prediction transform coefficient value, and restore the current block by performing an inverse transform on the second transform block based on the second DC transform coefficient value.

In accordance with an aspect of the disclosure, an image encoding method includes: selecting a current block from among a plurality of blocks obtained by dividing a current image; determining a plurality of transform blocks including a first transform block and a second transform block from the current block; scaling a first direct current (DC) transform coefficient value of the first transform block using a size of the first transform block and a reference transform size to obtain a scaled first DC transform coefficient value; obtaining a prediction transform coefficient value for the second transform block based on a size of the second transform block and the scaled first DC transform coefficient value; determining a residual DC transform coefficient value based on the prediction transform coefficient value and a second DC transform coefficient value of the second transform block; and generating a bitstream including information about the residual DC transform coefficient value.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an image encoding and decoding system according to an embodiment of the present disclosure;

FIG. 2A is a block diagram of an image encoding apparatus according to an embodiment of the present disclosure;

FIG. 2B is a block diagram of an image encoding apparatus according to an embodiment of the present disclosure;

FIG. 3A is a block diagram of an image decoding apparatus according to an embodiment of the present disclosure;

FIG. 3B is a block diagram of an image decoding apparatus according to an embodiment of the present disclosure;

FIG. 4 is a diagram illustrating blocks into which an image is divided, according to an embodiment of the present disclosure;

FIG. 5 is a diagram for explaining an encoding block and a transform block according to an embodiment of the present disclosure;

FIG. 6 is a diagram for explaining a scanning order of a transform block according to an embodiment of the present disclosure;

FIG. 7 is a diagram for explaining an entropy encoding process according to an embodiment of the present disclosure;

FIG. 8 is a diagram for explaining a syntax regarding a DC transform coefficient according to an embodiment of the present disclosure;

FIG. 9 is a diagram for explaining a syntax regarding an AC transform coefficient according to an embodiment of the present disclosure;

FIG. 10A is a diagram for explaining an entropy decoding process according to an embodiment of the present disclosure;

FIG. 10B is a diagram for explaining an entropy decoding process according to an embodiment of the present disclosure;

FIG. 11 is a diagram for explaining a structure of a bitstream according to an embodiment of the present disclosure;

FIG. 12 is a diagram for explaining a method of dividing an image, according to an embodiment of the present disclosure;

FIG. 13 is a diagram for explaining a process of determining the size of a transform block, according to an embodiment of the present disclosure;

FIG. 14 is a diagram for explaining a process of predicting a DC transform coefficient, according to an embodiment of the present disclosure;

FIG. 15 is a diagram for explaining a process of determining a reference block for predicting a DC transform coefficient, according to an embodiment of the present disclosure;

FIG. 16 is a diagram for explaining a process of predicting a DC transform coefficient, according to an embodiment of the present disclosure;

FIG. 17 is a diagram for explaining an entropy encoding method according to an embodiment of the present disclosure;

FIG. 18 is a diagram for explaining a process of determining the size of a transform block, according to an embodiment of the present disclosure;

FIG. 19 is a diagram for explaining information about the size of a transform block included in a bitstream according to an embodiment of the present disclosure;

FIG. 20 is a flowchart illustrating an image decoding method according to an embodiment of the present disclosure; and

FIG. 21 is a flowchart illustrating an image encoding method according to an embodiment of the present disclosure.

### DETAILED DESCRIPTION

The present disclosure may have various changes thereto and have various embodiments, and thus, specific embodiments of the present disclosure are illustrated in the accompanying drawings and will be described in detail in the following detailed description. However, it should be understood that the present disclosure is not limited to these embodiments and all changes, equivalents and replacements made thereto without departing from the spirit and scope of the present disclosure fall within the scope of the present disclosure.

Although terms used herein are from among general terms which are currently and broadly used while considering functions in the present disclosure, these terms may vary depending on intentions of those of ordinary skill in the art, precedents, the emergence of new technologies, or the like. In addition, there may be terms selected arbitrarily by the applicants in particular cases, and in these cases, the meaning of those terms will be described in detail in the corresponding portions of the detailed description. Therefore, the terms used herein should be defined based on the meaning thereof and descriptions made throughout the specification, rather than simply based on the names thereof.

The singular terms used herein are intended to include the plural forms as well, unless the context clearly indicates otherwise. In describing the embodiments, when it is determined that specific descriptions of related techniques known in the art may make the gist of the present disclosure unnecessarily unclear, detailed descriptions thereof are omitted. In addition, numbers (for example, 1^{st}, 2^{nd}, and the like) used herein to make descriptions are only identification symbols for distinguishing one component from another component.

Herein, it should be understood that, when one component is referred to as being “coupled to” or “connected to” another component, the one component may be directly coupled to or directly connected to the other component or may be coupled to or connected to the other component with an intervening component therebetween, unless otherwise stated.

It will be understood that, throughout the specification, when a region such as an element, a component, a layer, or the like is referred to as “comprising” or “including” a component such as an element, a region, a layer, or the like, the region may further include another component in addition to the component rather than exclude the other component, unless otherwise stated.

Herein, when a component is represented by the term such as “ . . . unit”, “ . . . portion”, “ . . . module”, or the like, two or more components may be integrated into one integrated component, or one component may be sub-divided into two or more sub-components according to functionality. In addition, regarding respective components described below, a component may additionally perform some or all of functions of another component, or some of functions of the component may be wholly responsible for and performed by the other component.

Also, the term “portion” used herein refers to a software or hardware component, and the “portion” performs predetermined roles. However, the “portion” is not limited to software or hardware. The “portion” may be configured to be on an addressable storage medium and may be configured to operate one or more processors. Therefore, as an example, the “portion” includes components, such as software components, object-oriented software components, class components, and task components, and processes, functions, properties, procedures, subroutines, segments of program code, drivers, firmware, microcode, circuitry, data, databases, data structures, tables, arrays, and variables. The functionality provided within the components and “portions” may be combined into a smaller number of components and “portions” or further separated into additional components and “portions.”

In an embodiment of the present disclosure, the “portion” may be implemented as a processor and a memory. The term “processor” should be broadly interpreted to include general-purpose processors, central processing units (CPUs), microprocessors, digital signal processors (DSPs), controllers, microcontrollers, state machines, or the like. In some circumstances, the term “processor” may also refer to application-specific integrated circuits (ASICs), programmable logic devices (PLDs), field programmable gate arrays (FPGAs), or the like. The term “processor” may also refer to a combination of processing devices, such as, for example, a combination of a DSP and a microprocessor, a combination of a plurality of microprocessors, a combination of one or more microprocessors in conjunction with a DSP core, or any other such combination of configurations.

The term “memory” should be broadly interpreted to include any electronic component capable of storing electronic information. The term “memory” may also refer to various types of processor-readable media, such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, or registers. A memory is said to be in electronic communication with a processor when the processor may read information from the memory and/or write information to the memory. A memory integrated in a processor is in electronic communication with the processor.

In the present disclosure, an “image” or “picture” may refer to a still image or moving image of a video, i.e., the video itself.

In the present disclosure, a “sample” or “signal” refer to data assigned to a sampling location of an image and to be processed. For example, pixel values in an image in the spatial domain, or transform coefficients in the transform domain may be samples. A unit including at least one of the samples may be defined as a block.

In the present disclosure, a direct current (DC) transform coefficient may refer to a transform coefficient having a frequency index of 0 in the frequency domain. A DC transform coefficient may be a transform coefficient in which both the horizontal and vertical coordinates of a transform block are located at the origin. Typically, within a transform block defined within a picture whose upper left point is the origin, an upper left transform coefficient may be the DC transform coefficient.

In the present disclosure, an alternating current (AC) transform coefficient may refer to a transform coefficient whose frequency index is not 0 in a one-dimensional frequency domain or a two-dimensional frequency domain. An AC transform coefficient may be a transform coefficient in which at least one of the horizontal and vertical coordinates of a transform block is located at a point other than the origin. Typically, within a transform block defined in a picture whose upper left point is the origin, an AC transform coefficient may be a transform coefficient excluding the upper left transform coefficient of the transform block.

In the present disclosure, the size of a block may refer to at least one of the width or the height of the block. For example, the size of a W×H block may refer to at least one of W, H, or W×H.

In the present disclosure, an arithmetic shift operation may refer to an operation that moves data in bit units. A right arithmetic shift operation may refer to shifting bits to the right. The right arithmetic shift operation may refer to dividing an operand by a power of 2. For example, performing a right arithmetic shift operation on 4 by 1 may mean that 4 (=100 (2)) is shifted to the right by 1 bit, resulting in 2 (=010 (2)). Performing a right arithmetic shift operation on A by B (or B-bit) may be expressed as A>>B. A left arithmetic shift operation may refer to shifting bits to the left. A left arithmetic shift operation may mean multiplying an operand by a power of 2. For example, performing a left arithmetic shift operation on 4 by 1 may mean that 4 (=100 (2)) is derived as a result by shifting 2 (=010 (2)) by 1 bit to the right. The left arithmetic shift operation may shift bits to the left, and 0 may be added to an empty space on the right. In an embodiment, the data may include a sign bit in the most significant bit. For example, when the sign bit is 0, it may mean that the data is positive, and when the sign bit is 1, it may mean that the data is negative. When the data includes a sign bit, the shift operation may be performed only with the remaining bits while maintaining the sign bit (most significant bit).

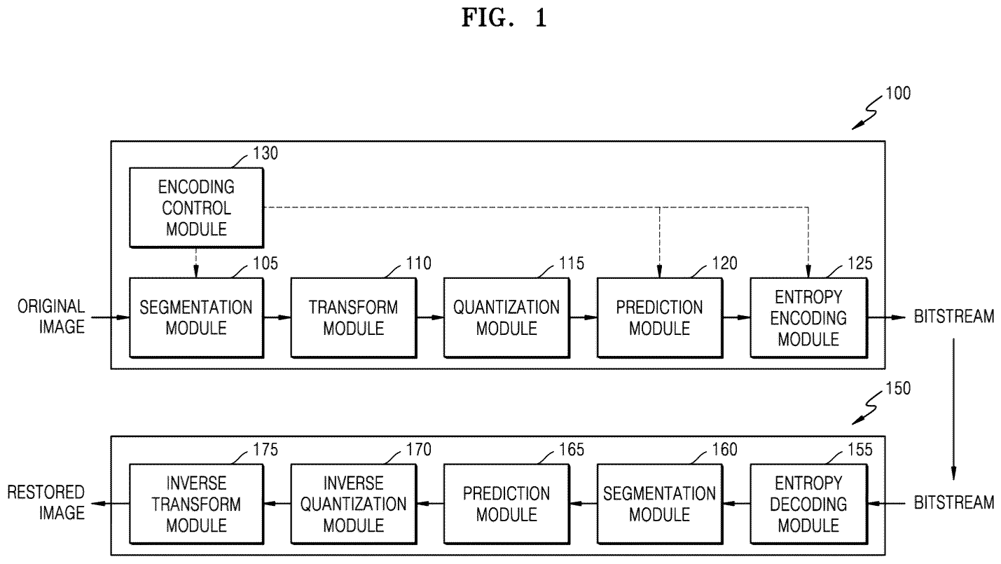

FIG. 1 is a block diagram of an image encoding and decoding system according to an embodiment of the present disclosure.

Referring to FIG. 1, the image encoding and decoding system may include an image encoding apparatus 100 and an image decoding apparatus 150.

The image encoding apparatus 100 may include a segmentation module 105, a transform module 110, a quantization module 115, a prediction module 120, an entropy encoding module 125, and an encoding control module 130. The image encoding apparatus 100 may generate a bitstream from an original image. For example, the image encoding apparatus 100 may receive an original image and generate a bitstream including information about encoding information of the original image.

The segmentation module 105 may segment (i.e., divide) the original image into a plurality of encoding blocks. According to an embodiment, the segmentation module 105 may segment the original image into a plurality of encoding blocks (e.g., macroblocks) having the same size. For example, the segmentation module 105 may segment the current image into macroblocks each having a size of 16×16. According to an embodiment, the segmentation module 105 may segment the original image into tiles or slices including a plurality of encoding blocks. For example, the segmentation module 105 may segment the original image into a plurality of tiles, and each of the plurality of tiles may include a plurality of encoding blocks. Similarly, the segmentation module 105 may segment the original image into a plurality of slices, and each of the plurality of slices may include a plurality of encoding blocks. The size of the encoding block may be determined for each tile or slice. That is, the size of an encoding block included in a first tile of the original image may be different from the size of an encoding block included in a second tile of the original image.

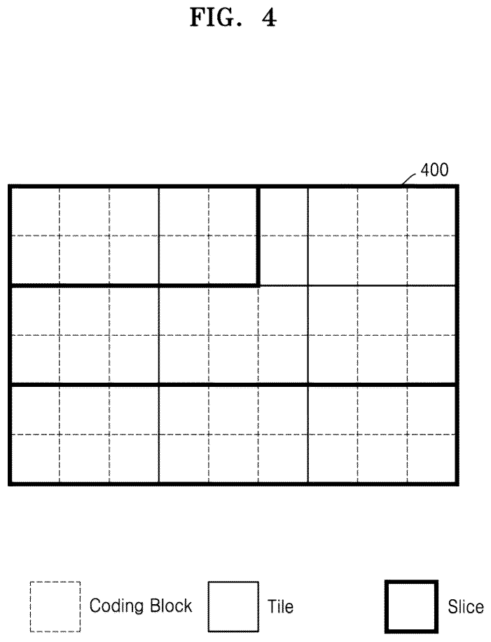

The segmentation module 105 may segment each encoding block into one or more transform blocks. The size of the transform block may be determined for each encoding block. For example, the segmentation module 105 may segment an encoding block having a size of 16×16 into 16 transform blocks each having a size of 4×4. The segmentation structure of an image according to an embodiment of the present disclosure is described in detail with reference to FIGS. 4, 5, 12, and 13.

The transform module 110 may perform a transform for each transform block among the current encoding blocks. For example, the transform module 110 may perform a transform in units of transform blocks each having a size of 8×8. According to an embodiment, the transform module 110 may perform a transform according to a transform block size determined for the current encoding block. According to an embodiment, the transform module 110 may perform a transform for a transform block determined by the segmentation module 105. The transform module 110 may perform a transform to determine a transform coefficient. The transform may refer to changing a signal in the spatial domain of the current encoding block into a signal in the frequency domain or the transform domain. The transform may include at least one of a discrete cosine transform (DCT) or a discrete sine transform (DST). According to an embodiment, the transform coefficient may include a DC transform coefficient and an AC transform coefficient.

The quantization module 115 may perform quantization on the transform coefficient. The quantization module 115 may perform quantization to determine a quantized transform coefficient. Quantization may refer to approximating the transform coefficient to a predetermined representative value. According to an embodiment, uniform quantization or scalar quantization may be performed, or quantization may be performed by adaptively applying a quantization step size for each transform coefficient through a quantization matrix.

The prediction module 120 may predict the quantized transform coefficient for each transform block. In an embodiment of the present disclosure, the prediction module 120 may also predict the current transform coefficient by using already predicted transform coefficients. The prediction module 120 may predict the transform coefficient of the current transform block by using the transform coefficient of a transform block on which prediction has been previously performed. For example, the prediction module 120 may predict the DC transform coefficient of the current transform block by using the DC transform coefficient of a transform block on which prediction has been previously performed.

According to an embodiment, the prediction module 120 may determine a reference block for predicting the DC transform coefficient of the current transform block. A block that is used by the prediction module 120 to perform prediction may be referred to as a reference block. The prediction module 120 may predict the DC transform coefficient of the current transform block based on the DC transform coefficient value of the reference block. The prediction module 120 may determine a residual DC transform coefficient based on the quantized DC transform coefficient of the current transform block and the DC transform coefficient of the reference block. The residual DC transform coefficient may be a value for the difference between the quantized DC transform coefficient of the current transform block and the DC transform coefficient of the reference block.

According to an embodiment, the prediction module 120 may perform prediction by referring to a transform block on which prediction has been previously performed, the transform block being included in the same tile or slice as a transform block to be predicted. The prediction module 120 may determine a reference block differently for each color component. For example, the prediction module 120 may separately determine a reference block for a luma block and a reference block for a chroma block. The reference block for a luma block and the reference block for a chroma block may not be included in the same block.

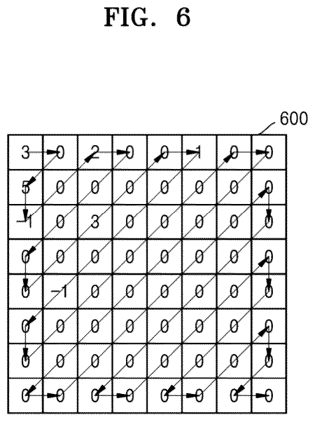

The entropy encoding module 125 may perform entropy encoding on information about transform coefficients on which prediction has been performed. The entropy encoding module 125 may entropy-encode information about DC transform coefficients and information about AC transform coefficients. In an embodiment, the information about DC transform coefficients may include a syntax element about residual DC transform coefficients. The process of performing, by the entropy encoding module 125, entropy encoding on the information about DC transform coefficients according to an embodiment of the present disclosure is described in detail with reference to FIGS. 6, 7, and 11. The entropy encoding may include variable length coding (VLC), universal VLC, or arithmetic coding.

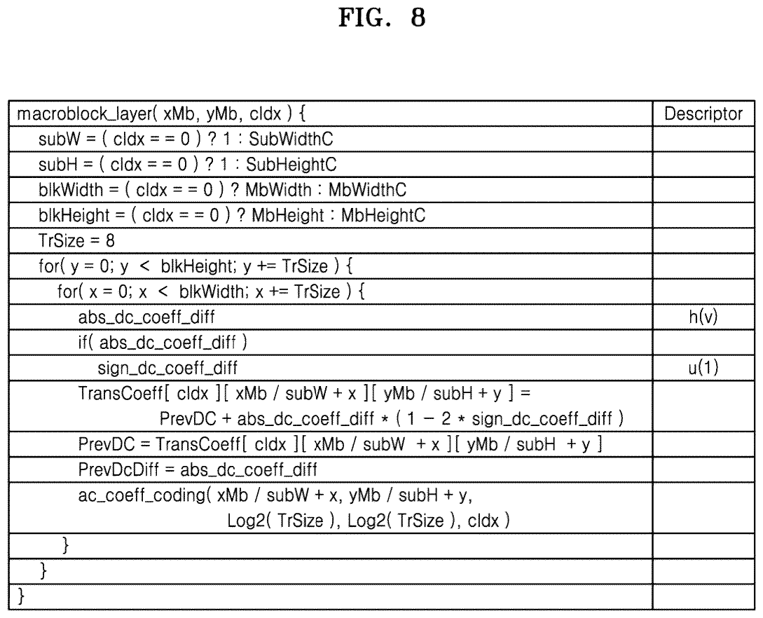

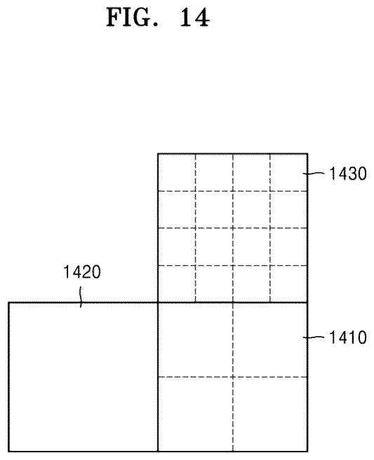

The encoding control module 130 may perform rate control or adjust a method of dividing (i.e., segmenting) an image. The image encoding apparatus 100 may generate a bitstream including entropy-encoded information. The image encoding apparatus 100 may transmit the bitstream to the image decoding apparatus 150. The structure of the bitstream according to an embodiment of the present disclosure is described in detail with reference to FIGS. 8 and 14.

The image decoding apparatus 150 may include an entropy decoding module 155, a segmentation module 160, a prediction module 165, an inverse quantization module 170, and an inverse transform module 175. The image decoding apparatus 150 may generate a restored image from the bitstream. For example, the image decoding apparatus 150 may obtain a bitstream and generate an original image by using information included in the bitstream.

The entropy decoding module 155 may perform entropy decoding on the bitstream. The entropy decoding module 155 may obtain encoding information corresponding to a syntax element from a bitstream. The entropy decoding module 155 may perform entropy decoding on the bitstream to obtain a syntax element regarding a DC transform coefficient. Information about the DC transform coefficient may include a residual DC transform coefficient. The entropy decoding module 155 may perform entropy decoding on the bitstream to obtain a syntax element regarding an AC transform coefficient. The process of performing entropy decoding may be a reverse process of the process of performing entropy encoding.

The segmentation module 160 may segment an image into a plurality of encoding blocks. In an embodiment, the segmentation module 160 may segment an image based on segmentation information obtained from the bitstream. The segmentation information may include information about the size of at least one of a tile, a slice, an encoding block, or a transform block. The segmentation module 160 may segment an image in the same manner as the segmentation module 105. The segmentation module 160 may segment an image into tiles, slices, encoding blocks, and transform blocks in the same manner as the segmentation module 105.

The prediction module 165 may perform prediction for each transform block. The prediction module 165 may predict the transform coefficient of the current transform block by using the transform coefficient of a transform block on which prediction has been previously performed. According to an embodiment, the prediction module 165 may predict the DC transform coefficient of the current transform block by using the DC transform coefficient of a transform block on which prediction has been previously performed.

According to an embodiment, the prediction module 165 may determine a reference block for predicting the DC transform coefficient of the current transform block. A block that is used by the prediction module 165 to perform prediction may be referred to as a reference block. The prediction module 165 may predict the DC transform coefficient of the current transform block based on the DC transform coefficient value of the reference block. The prediction module 165 may determine the DC transform coefficient of the current transform block based on the DC transform coefficient and the residual DC transform coefficient of the reference block. For example, the prediction module 165 may determine the DC transform coefficient of the current transform block by summing the DC transform coefficient and the residual DC transform coefficient of the reference block. The residual DC transform coefficient may be determined based on information included in the bitstream.

According to an embodiment, the prediction module 165 may predict the AC transform coefficient of the current transform block based on the DC transform coefficient of the current transform block. The AC transform coefficient may be determined based on information included in the bitstream.

According to an embodiment, the prediction module 165 may perform prediction by referring to a transform block on which prediction has been previously performed, the transform block being included in the same tile or slice as a transform block to be predicted. The prediction module 165 may determine a reference block differently for each color component. For example, the prediction module 165 may separately determine a reference block for a luma block and a reference block for a chroma block. The reference block for a luma block and the reference block for a chroma block may not be included in the same block.

According to an embodiment, the inverse quantization module 170 may perform inverse quantization on transform coefficients. The inverse quantization module 170 may perform inverse quantization to determine the inverse quantized transform coefficients. Inverse quantization may refer to an operation to restore a quantized value to a value before quantization by performing the quantization in reverse.

According to an embodiment, the inverse transform module 175 may perform inverse transform on the inverse quantized transform coefficients. The inverse transform module 175 may change a signal in the frequency domain into a signal in the spatial domain. The inverse transform module 175 may perform inverse transform to generate a restored image.

The image encoding apparatus 100 and the image decoding apparatus 150 according to an embodiment of the present disclosure may generate a restored image with less loss from a high-resolution image. The image encoding apparatus 100 and the image decoding apparatus 150 according to an embodiment of the present disclosure may increase compression efficiency while utilizing low complexity.

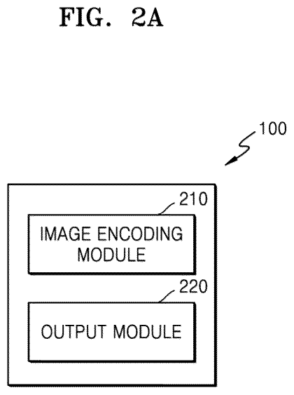

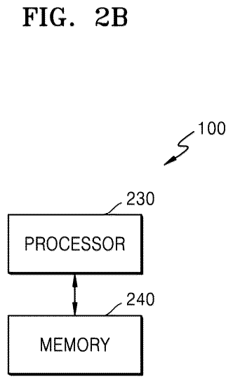

FIG. 2A is a block diagram of an image encoding apparatus according to an embodiment of the present disclosure.

Referring to FIG. 2A, an image encoding apparatus 100 according to an embodiment of the present disclosure may include an image encoding module 210 and an output module 220. According to an embodiment, the image encoding module 210 may include at least one processor and a memory storing instructions to be performed by the at least one processor. The image encoding module 210 and the output module 220 may be implemented as separate hardware, or the image encoding module 210 and the output module 220 may be included in one hardware.

The image encoding module 210 may encode a current image. The image encoding module 210 may generate a bitstream from the current image.

The image encoding module 210 may divide the current image into a plurality of encoding block units. According to an embodiment, the encoding block units may be macroblocks. The image encoding module 210 may determine the transform coefficient of a transform block by performing a transform on an encoding block. The image encoding module 210 may perform quantization on the transform coefficient. The image encoding module 210 may perform a prediction process on the DC transform coefficient of a quantized block. The image encoding module 210 may perform entropy encoding on coefficients on which prediction has been performed.

The output module 220 may output a bitstream including at least one of information about the size of the encoding block, information about the size of the transform block, information about the DC transform coefficient, and information about the AC transform coefficient.

The image encoding module 210 may determine the current block among a plurality of blocks divided from the current image. The image encoding module 210 may determine a plurality of transform blocks including a first transform block and a second transform block from the current block. The image encoding module 210 may scale the first DC transform coefficient value of the first transform block by using the size of the first transform block and a reference transform size. The image encoding module 210 may obtain a prediction transform coefficient value for the second transform block by using the size of the second transform block and the scaled first DC transform coefficient value. The image encoding module 210 may determine a residual DC transform coefficient value by using the prediction transform coefficient value and the second DC transform coefficient value of the second transform block. The image encoding module 210 may generate a bitstream including information about the residual DC transform coefficient value.

FIG. 2B is a block diagram of an image encoding apparatus according to an embodiment of the present disclosure.

Referring to FIG. 2B, an image encoding apparatus 100 according to an embodiment may include a memory 230 and at least one processor 240 connected to the memory 230. The image encoding apparatus 100 according to an embodiment may operate as individual processors or may be operated under the control of a central processor. The memory 230 of the image encoding apparatus 100 may store data received from the outside and data generated by the at least one processor 240.

The memory 230 of the image encoding apparatus 100 according to an embodiment may include at least one instruction configured to be executable by the at least one processor 240. The at least one processor 240 may determine a current block among a plurality of blocks divided from a current image by executing at least one instruction stored in the memory 230. The at least one processor 240 may determine a plurality of transform blocks including a first transform block and a second transform block from the current block. The at least one processor 240 may scale a first DC transform coefficient value of the first transform block by using the size of the first transform block and a reference transform size. The at least one processor 240 may obtain a prediction transform coefficient value for the second transform block by using the size of the second transform block and the scaled first DC transform coefficient value. The at least one processor 240 may determine a residual DC transform coefficient value by using the prediction transform coefficient value and the second DC transform coefficient value of the second transform block. The at least one processor 240 may generate a bitstream including information about the residual DC transform coefficient value.

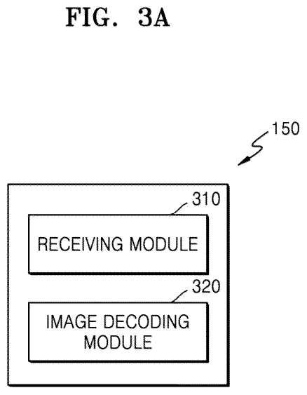

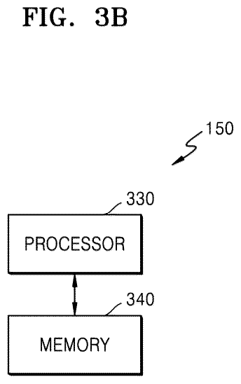

FIG. 3A is a block diagram of an image decoding apparatus according to an embodiment of the present disclosure.

Referring to FIG. 3A, an image decoding apparatus 150 according to an embodiment may include a receiving module 310 and an image decoding module 320. The receiving module 310 and the image decoding module 320 may be implemented as separate hardware, or the receiving module 310 and the image decoding module 320 may be included in one hardware.

The receiving module 310 may receive a bitstream. The bitstream includes information obtained by encoding an image via the image encoding apparatus 100 described below. The bitstream may be transmitted from the image encoding apparatus 100. The image encoding apparatus 100 and the image decoding apparatus 150 may be connected to each other by wire or wirelessly, and the receiving module 310 may receive the bitstream by wire or wirelessly. The receiving module 310 may receive the bitstream from a storage medium, such as an optical medium or a hard disk. The receiving module 310 may transmit the received bitstream or information identified from the bitstream to the image decoding module 320.

According to an embodiment, the image decoding module 320 may include at least one processor and a memory storing instructions to be performed by the at least one processor. The image decoding module 320 may restore an image based on information obtained from a received bitstream. The image decoding module 320 may obtain, from the bitstream, a syntax element for restoring an image. The image decoding module 320 may restore an image based on the syntax element.

The image decoding module 320 may determine a current block among a plurality of blocks divided from a current image. The image decoding module 320 may determine a plurality of transform blocks including a first transform block and a second transform block from the current block. The image decoding module 320 may scale a first DC transform coefficient value of the first transform block by using the size of the first transform block and a reference transform size. The image decoding module 320 may obtain a prediction transform coefficient value for the second transform block by using the size of the second transform block and the scaled first DC transform coefficient value. The image decoding module 320 may determine a second DC transform coefficient value of the second transform block by using the prediction transform coefficient value. The image decoding module 320 may perform inverse transform on the second transform block by using the second DC transform coefficient value to restore the current block.

FIG. 3B is a block diagram of an image decoding apparatus according to an embodiment of the present disclosure.

Referring to FIG. 3B, an image decoding apparatus 150 according to an embodiment of the present disclosure may include a memory 340 and at least one processor 330 connected to the memory 340. The image decoding apparatus 150 according to an embodiment may operate as individual processors or may be operated under the control of a central processor. In addition, the memory 340 of the image decoding apparatus 150 may store data received from the outside and data generated by the at least one processor 330.

The memory 340 of the image decoding apparatus 150 may include at least one instruction configured to be executable by the at least one processor 330. The at least one processor 330 may determine a current block among a plurality of blocks divided from a current image by executing at least one instruction stored in the memory 340. The at least one processor 330 may determine a plurality of transform blocks including a first transform block and a second transform block from the current block. The at least one processor 330 may scale a first DC transform coefficient value of the first transform block by using the size of the first transform block and a reference transform size. The at least one processor 330 may obtain a prediction transform coefficient value for the second transform block by using the size of the second transform block and the scaled first DC transform coefficient value. The at least one processor 330 may determine a second DC transform coefficient value of the second transform block by using the prediction transform coefficient value. The at least one processor 330 may perform inverse transform on the second transform block by using the second DC transform coefficient value to restore the current block.

FIG. 4 is a diagram illustrating blocks into which an image is divided, according to an embodiment of the present disclosure.

One image 400 may be divided (i.e., segmented) into one or more slices or one or more tiles. One slice may include a plurality of tiles.

One slice or one tile may be a sequence of one or more encoding blocks (i.e., coding blocks). The slice may include an integer number of tiles or an integer number of encoding blocks. The tile may include Mx N encoding blocks having the same size. Referring to FIG. 4, the tile includes 3×2 encoding blocks having the same size. According to an embodiment, the size of the encoding block may be determined differently for each tile. Encoding and decoding may be performed independently for each tile. In an embodiment, the encoding block may be a macroblock.

One or more transform units for transform and quantization may be determined from the encoding block. The size of the transform unit may be the same as that of the encoding block or smaller than that of the encoding block. The transform unit may be a reference block for transform and quantization. Pixel values of the encoding block may be transformed and quantized for each transform unit within the encoding block.

In the present disclosure, the current block may be a slice, a tile, an encoding block, or a transform unit segmented from an image 400. A lower block of the current block may be a block segmented from the current block, and for example, when the current block is an encoding block, the lower block may be a transform unit. In addition, an upper block of the current block may be a block that includes the current block as a part, and for example, when the current block is an encoding block, the upper block may be a picture sequence, a picture, a slice, or a tile.

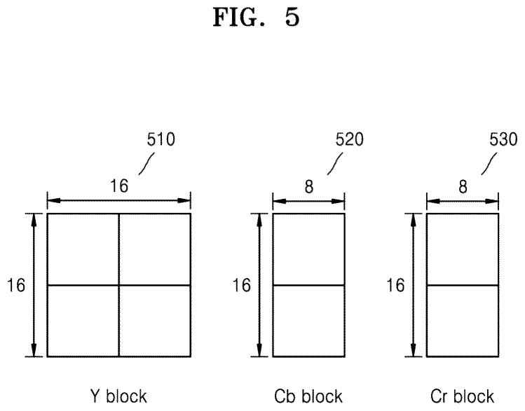

FIG. 5 is a diagram for explaining an encoding block and a transform block according to an embodiment of the present disclosure.

Referring to FIG. 5, an encoding block according to an embodiment of the present disclosure may include a luma block 510 and chroma blocks 520 and 530. The luma block 510 may refer to a block of luma samples in the encoding block. In an embodiment, the luma block 510 may refer to a Y block. The chroma blocks 520 and 530 may refer to blocks of chroma samples in the encoding block. In an embodiment, the chroma blocks 520 and 530 may include a Cb block and a Cr block. The color format of the encoding block may be one of 4:4:4, 4:2:2, 4:2:0, or monochrome.

When the size of the encoding block is 16×16 and the color format is 4:2:2, the encoding block may include a luma block of 16×16 and a chroma block of 8×16. According to an embodiment, when the size of a transform block is 8×8, a luma block may be divided into four 8×8 blocks, and a chroma block may be divided into two 8×8 blocks. According to an embodiment, the transform block sizes of the luma block and the chroma block may be determined to be different from each other. According to an embodiment, the image encoding apparatus 100 and the image decoding apparatus 150 may respectively perform encoding and decoding for each divided transform block. The transform blocks determined by dividing the encoding block may be determined according to a predetermined order (e.g., a raster scan order or a z scan order). The raster scan order refers to a method of sequentially performing scanning in a horizontal direction (the same row), and then proceeding to the next line (the next row) when the scanning in the horizontal direction is finished to sequentially perform scanning in the horizontal direction.

FIG. 6 is a diagram for explaining a scanning order of a transform block according to an embodiment of the present disclosure.

Referring to FIG. 6, a transform block 600 is an 8×8 block including 64 transform coefficients. The transform block 600 may be scanned according to a z scan order (or a zig-zag scan). The image encoding apparatus 100 may perform entropy encoding on the transform block 600 according to the z scan order.

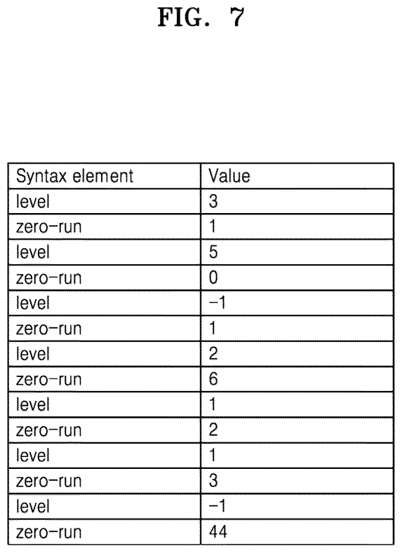

The image encoding apparatus 100 may sequentially perform scanning from a DC transform coefficient of the transform block 600 to a last AC transform coefficient thereof. The image encoding apparatus 100 may start scanning from 3, which is a DC transform coefficient of the transform block 600, and sequentially perform scanning to 0, which is a last AC transform coefficient. The image encoding apparatus 100 may sequentially perform scanning in a diagonal direction. Referring to FIG. 6, the image encoding apparatus 100 may perform scanning in the order of “3->0->5->−1->0-> . . . >0”. An entropy encoding method according to an embodiment of the present disclosure will be described in detail with reference to FIG. 7.

FIG. 7 is a diagram for explaining an entropy encoding process according to an embodiment of the present disclosure.

Referring to FIG. 7, transform coefficients included in the transform block of FIG. 6 may be encoded using syntax elements “level” and “zero-run”. The level may refer to a value of a transform coefficient that is not 0. The zero-run may refer to the number of consecutive 0 transform coefficients. The process of encoding the coefficients by using the level and the zero-run may be referred to as run-level coding or run-length coding.

Referring to FIG. 6, because the DC transform coefficient value is 3, the value of the level in FIG. 7 may be determined to be 3. Because there is one 0 transform coefficient after the transform coefficient “3”, the value of the zero-run may be determined to be 1. Because the transform coefficient after the 0 transform coefficient is 5, the value of the level may be determined to be 5. Similarly, all transform coefficients of the transform block may be encoded using the level and the zero-run. According to an embodiment, the image encoding apparatus 100 may encode a transform block by using run-length encoding. The image encoding apparatus 100 may generate a bitstream by entropy encoding the syntax elements “level” and “zero-run”. According to an embodiment, the image decoding apparatus 150 may perform entropy decoding on the bitstream to obtain the syntax elements “level” and “zero-run”. The image decoding apparatus 150 may perform entropy decoding on level and zero-run syntax elements according to a run-length encoding method to determine a transform coefficient.

FIG. 8 is a diagram for explaining a syntax regarding a DC transform coefficient according to an embodiment of the present disclosure.

Referring to FIG. 8, a syntax element regarding a DC transform coefficient may be included in a macroblock layer syntax. According to an embodiment, a macroblock of the macroblock syntax may be an encoding block of FIG. 1.

Input data of the macroblock layer syntax may be the position xMb and yMb and color component index cIdx (e.g., Y component is 0, Cb component is 1, Cr component is 2) of a current macroblock in a frame.

According to an embodiment of the present disclosure, a width ratio subW and a height ratio subH may be determined based on a color format. When the color format is 4:2:2, SubWidthC and SubHeightC may be 2 and 1, respectively. When the color format is 4:2:0, SubWidthC and SubHeightC may both be 2. When the color format is not 4:2:2 and 4:2:0, SubWidthC and SubHeightC may both be 1.

In an embodiment of the present disclosure, a width blkWidth of a block may be determined based on a width MbWidth of the macroblock, and a height blkHeight of the block may be determined based on a height MbHeight of the macroblock. blkWidth may be determined to be one of Mb Width or MbWidthC based on cIdx. Mb WidthC may be determined to be MbWidth/SubWidthC. blkHeight may be determined to be one of MbHeight or MbHeightC based on cIdx. MbHeightC may be determined to be MbHeight/SubHeightC.

The macroblock layer syntax may include a syntax element regarding a DC transform coefficient. The macroblock layer syntax may include a syntax element abs_dc_coeff_diff regarding an absolute value of a residual DC transform coefficient and a syntax element sign_dc_coeff_diff regarding a sign of the residual DC transform coefficient. The syntax element regarding the sign of the residual DC transform coefficient may be obtained only when the syntax element regarding the absolute value of the residual DC transform coefficient is not 0. According to an embodiment, the image encoding apparatus 100 may generate a bitstream of a macroblock layer syntax including the syntax element regarding the absolute value of the residual DC transform coefficient and the syntax element regarding the sign of the residual DC transform coefficient. In addition, the image decoding apparatus 150 may parse the syntax element regarding the absolute value of the residual DC transform coefficient and the syntax element regarding the sign of the residual DC transform coefficient from the bitstream of the macroblock layer syntax. In an embodiment, a transform coefficient TransCoeff[ ] [ ] may be determined using a syntax element regarding PrevDC and a DC transform coefficient. In an embodiment, PrevDC may be updated based on the value of a transform coefficient. The initial value of PrevDC may be determined to be 0. In an embodiment, a previous residual DC value PrevDcDiff may be updated based on the absolute value of a residual DC transform coefficient. The initial value of PrevDcDiff may be determined to be 40. The macroblock layer syntax may call an AC transform coefficient encoding syntax.

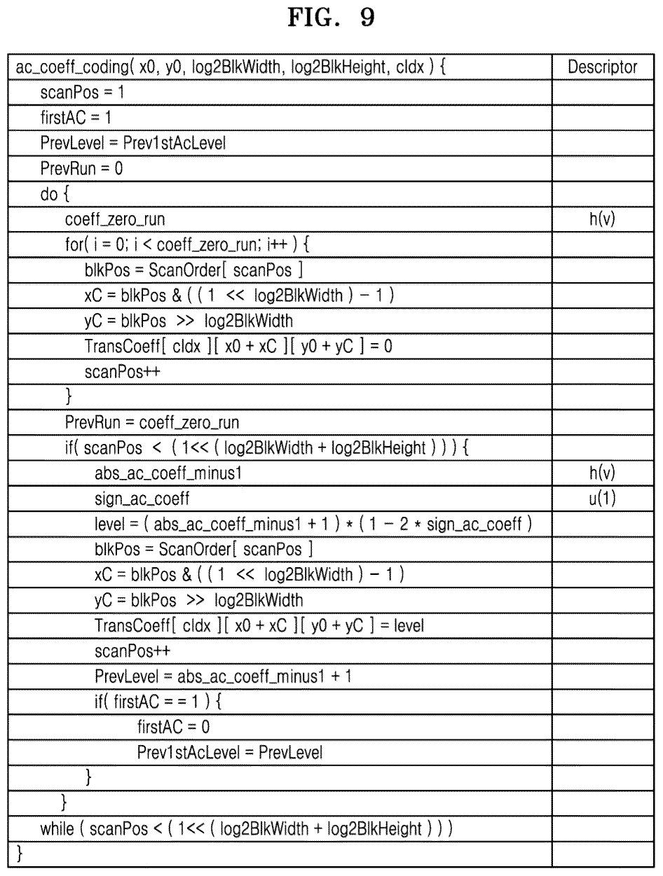

FIG. 9 is a diagram for explaining a syntax regarding an AC transform coefficient according to an embodiment of the present disclosure.

Referring to FIG. 9, an AC transform coefficient encoding syntax may include a syntax element regarding an AC transform coefficient. The input data of the AC transform coefficient encoding syntax may include a position (x0, y0) of the AC transform coefficient, a size log 2BlkWidth and log 2BlkHeight of a transform block, and a color component index cIdx. The variables scan position scanPos, first AC firstAC, previous level PrevLevel, and previous zero-run PrevRun of the AC transform coefficient encoding syntax may be initialized. The initial value of Prev1stAcLevel may be determined to be 0.

The syntax element regarding an AC transform coefficient may include a syntax element coeff_zero_run regarding zero-run, a syntax element abs_ac_coeff_minus1 regarding an absolute value of the AC transform coefficient, and a syntax element sign_ac_coeff regarding a sign of the AC transform coefficient. According to an embodiment, the image encoding apparatus 100 may generate a bitstream of an AC transform coefficient encoding syntax including the syntax element regarding the zero-run, the syntax element regarding the absolute value of the AC transform coefficient, and the syntax element regarding the sign of the AC transform coefficient. In addition, the image decoding apparatus 150 may parse the syntax element regarding the zero-run, the syntax element regarding the absolute value of the AC transform coefficient, and the syntax element regarding the sign of the AC transform coefficient from the bitstream of the AC transform coefficient encoding syntax.

The syntax element regarding the zero-run may be the syntax element regarding zero-run, described with reference to FIG. 7. Based on the syntax element regarding the zero-run, a transform coefficient may be determined. For example, when the value of the syntax element regarding the zero-run is 5, the values of five consecutive transform coefficients according to a scan order may be determined to be 0. In an embodiment, ScanOrder of FIG. 9 may be a function that converts a z scan to a raster scan. The previous zero-run PrevRun may be updated using the syntax element regarding the zero-run.

After the value of a transform coefficient is determined to be 0 by using the syntax element regarding the zero-run, a syntax element regarding the value of the AC transform coefficient may be obtained. A syntax element abs_ac_coeff_minus1 regarding the absolute value of the AC transform coefficient may refer to a value obtained by subtracting 1 from the absolute value of the AC transform coefficient. A syntax element sign_ac_coeff regarding the sign of the AC transform coefficient may refer to the sign of the AC transform coefficient.

The value of the AC transform coefficient that is not 0 may be determined based on the syntax element regarding the absolute value of the AC transform coefficient and the syntax element regarding the sign of the AC transform coefficient. The previous level PrevLevel may be updated based on the syntax element regarding the absolute value of the AC transform coefficient.

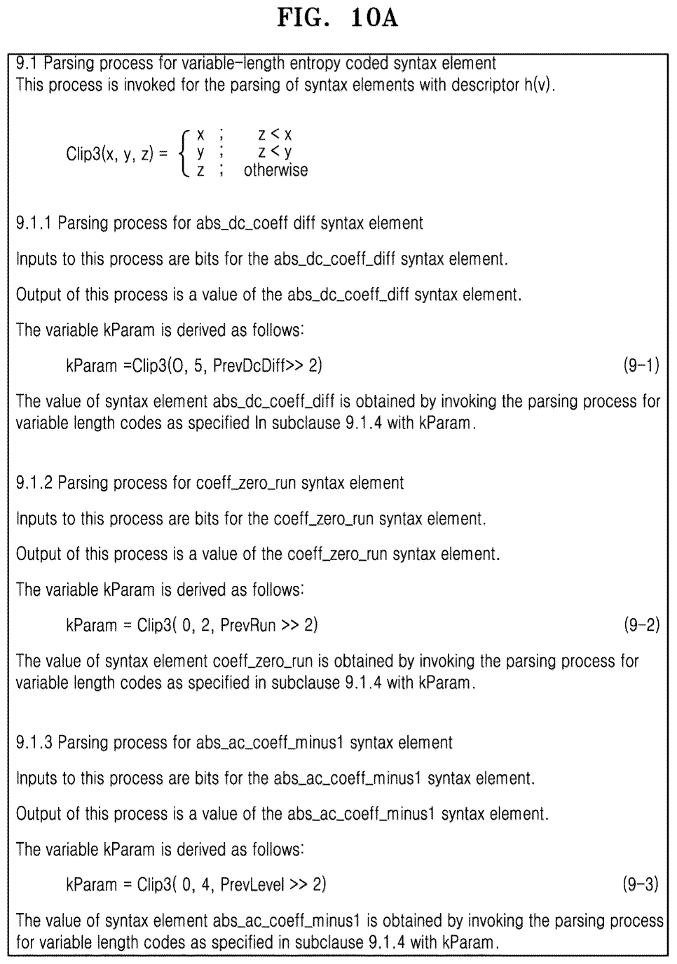

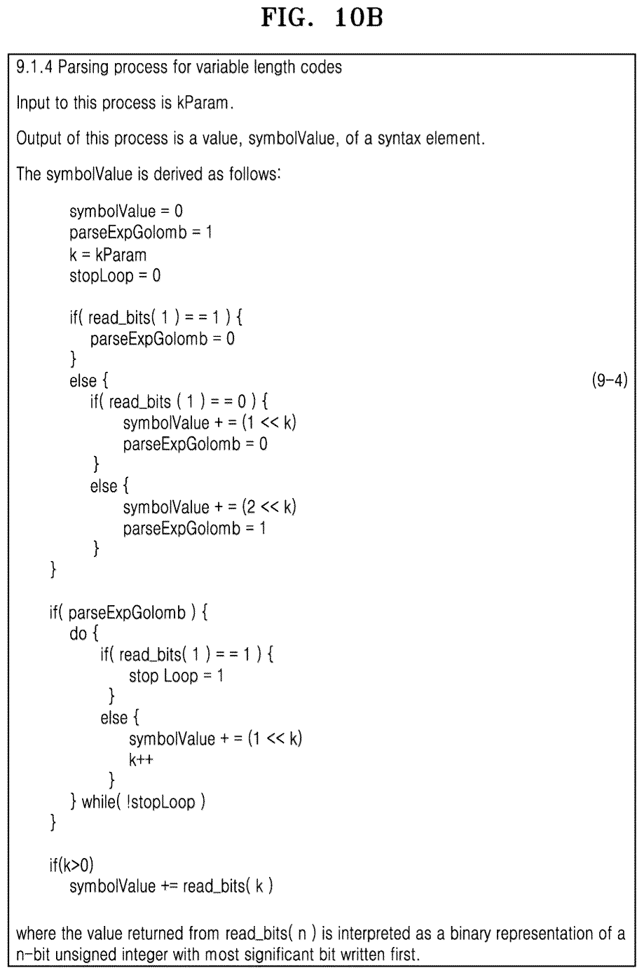

The process of determining a transform coefficient by using the syntax element regarding the AC transform coefficient may be repeated until all the AC transform coefficients of the transform block are determined. An entropy encoding process for a syntax element according to an embodiment of the present disclosure is described in detail with reference to FIGS. 10A and 10B.

FIG. 10A is a diagram for explaining an entropy decoding process according to an embodiment of the present disclosure.

Referring to FIG. 10A, an entropy decoding process for a syntax element is described. According to an embodiment, the syntax element abs_dc_coeff_diff regarding the absolute value of the residual DC transform coefficient of FIG. 8, the syntax element coeff_zero_run regarding the zero-run of FIG. 9, and the syntax element abs_ac_coeff_minus1 regarding the absolute value of the AC transform coefficient of FIG. 9 may be entropy-encoded by using variable-length coding.

Decoding using the variable-length coding, i.e., a variable-length decoding process, is as follows.

A value for the abs_de_coeff_diff syntax element may be obtained by performing variable-length decoding on a bit string of the abs_de_coeff_diff syntax element. A parameter kParam used for entropy decoding may be determined based on the previous residual DC value PrevDcDiff of FIG. 8. The parameter kParam used for entropy decoding may be determined by Equation (9-1) shown in FIG. 10A. The value for the abs_dc_coeff_diff syntax element may be obtained by performing variable-length decoding using the parameter kParam.

A value for the coeff_zero_run syntax element may be obtained by performing variable-length decoding on a bit string of the coeff_zero_run syntax element. The parameter kParam used for entropy decoding may be determined based on the previous zero-run PrevRun of FIG. 9. The parameter kParam used for entropy decoding may be determined by Equation (9-2) shown in FIG. 10A. The value for the coeff_zero_run syntax element may be obtained through variable-length decoding using the parameter kParam.

A value for the abs_ac_coeff_minus1 syntax element may be obtained by performing variable-length decoding on a bit string of the abs_ac_coeff_minus1 syntax element. The parameter kParam used for entropy decoding may be determined based on the previous level PrevLevel of FIG. 9. The parameter kParam used for entropy decoding may be determined by Equation (9-3) shown in FIG. 10A. The value for the abs_ac_coeff_minus1 syntax element may be obtained through variable length decoding using the parameter kParam.

FIG. 10B is a diagram for explaining an entropy decoding process according to an embodiment of the present disclosure.

Referring to FIG. 10B, a value symbolValue of a syntax element may be inferred using the parameter kParam used for the variable length decoding of FIG. 10A. According to an embodiment, the value symbolValue of the syntax element may be determined by identifying (read_bits(1)) bits of the syntax element one by one.

The image encoding apparatus 100 according to an embodiment may entropy-encode at least one of the value of a residual DC transform coefficient, the value of zero-run of the AC transform coefficient, and the value of the AC transform coefficient. The image decoding apparatus 150 may entropy-decode at least one of a syntax element regarding the residual DC transform coefficient, a syntax element regarding the zero-run, and a syntax element regarding the absolute value of the AC transform coefficient.

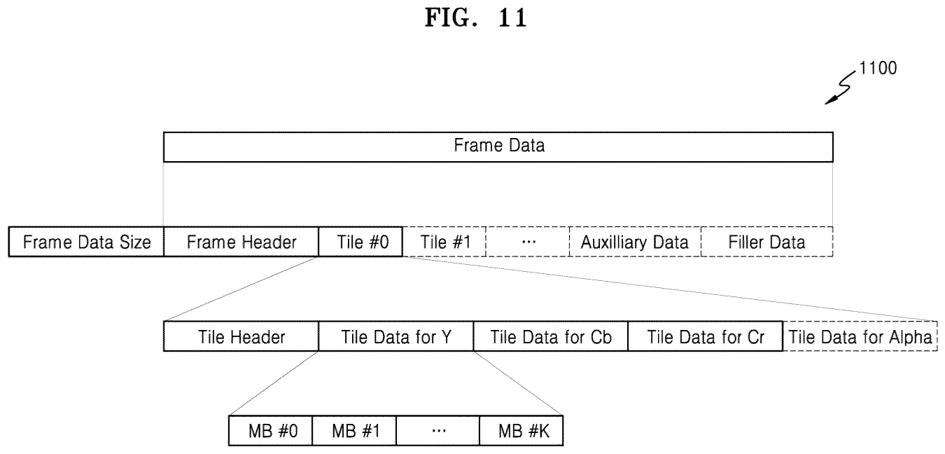

FIG. 11 is a diagram for explaining a structure of a bitstream according to an embodiment of the present disclosure.

Referring to FIG. 11, a bitstream 1100 according to an embodiment of the present disclosure may include a frame data size and frame data. The frame data may include a frame header, data Tile #0, . . . , and Tile #M regarding tiles, auxiliary data, and filter data. The frame header may include information indicating that a tile may be divided into one or more macroblocks.

The data regarding tiles may include data regarding each tile included in a frame. The data regarding tiles may include a tile header and tile data. The tile header may include color component-specific information applied in tile units. For example, the tile header may include color component-specific quantization parameters (QPs) applied in tile units. The tile data may include tile data Tile Data for Y of a luma component, tile data Tile Data for Cb and Tile Data for Cr of a chroma component, and tile data Tile Data for Alpha of an alpha component.

The tile data may include data MB #0, . . . , and MB #K regarding macroblocks. Macroblocks in a tile may be listed in a raster order. The tile data may include data about macroblocks for each color component. That is, each of the tile data of the luma component and the tile data of the chroma component may include data about macroblocks. The data about macroblocks may include data about each macroblock included in the tile. According to an embodiment, the macroblock of FIG. 11 may refer to the encoding block of FIG. 1.

In an embodiment, the bitstream may include slice data including one or more pieces of tile data or one or more pieces of macroblock data.

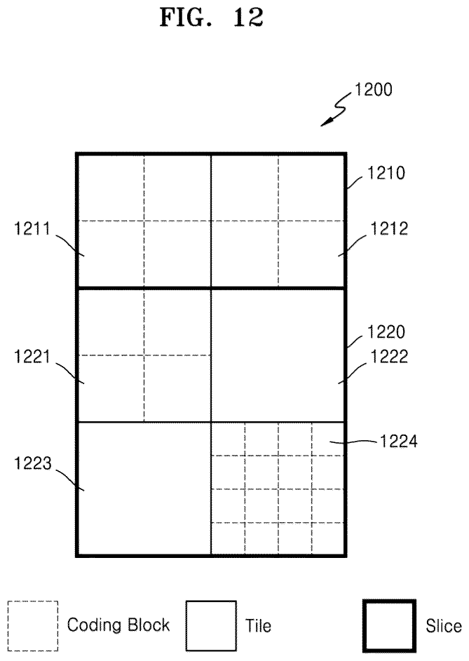

FIG. 12 is a diagram for explaining a method of dividing an image, according to an embodiment of the present disclosure.

Referring to FIG. 12, an image 1200 may include a first slice 1210 and a second slice 1220. The image decoding apparatus 150 according to an embodiment of the present disclosure may divide the image 1200 into the first slice 1210 and the second slice 1220.

According to an embodiment, the image decoding apparatus 150 may determine the size of an encoding block for a slice. The image decoding apparatus 150 may obtain information about the size of an encoding block for a slice from a bitstream. According to an embodiment, the information about the size of an encoding block for a slice may be included in a slice header of the bitstream. When determining the size of an encoding block for each slice, the image decoding apparatus 150 may determine the size of a tile to be a multiple of the size of the largest encoding block.

The image decoding apparatus 150 may determine the size of an encoding block included in the first slice 1210 to be a predetermined size (e.g., 8×8). The first slice 1210 may include a first tile 1211 and a second tile 1212. The image decoding apparatus 150 may restore one or more encoding blocks included in the first tile 1211 and the second tile 1212 based on the size of the encoding block for the first slice 1210. Referring to FIG. 12, the first tile 1211 and the second tile 1212 may each include four encoding blocks each having a predetermined size.

According to an embodiment, the image decoding apparatus 150 may determine the size of the encoding block for the tile. The image decoding apparatus 150 may obtain information about the size of the encoding block for the tile from a bitstream. According to an embodiment, the information about the size of the encoding block for the tile may be included in the tile header of the bitstream. When determining the size of the encoding block for each tile, the image decoding apparatus 150 may determine the size of the tile to be a multiple of the size of the largest encoding block.

The image decoding apparatus 150 may divide the second slice 1220 into a third tile 1221, a fourth tile 1222, a fifth tile 1223, and a sixth tile 1224. The image decoding apparatus 150 may determine the size of an encoding block included in each of the tiles 1221, 1222, 1223, and 1224 to be a predetermined size for each tile. For example, the image decoding apparatus 150 may divide the third tile 1221 into one or more encoding blocks based on the size of the encoding block for the third tile 1221. Referring to FIG. 12, the image decoding apparatus 150 may divide the third tile 1221 into four encoding blocks each having a predetermined size. For example, the image decoding apparatus 150 may divide the fourth tile 1222 and the fifth tile 1223 into one encoding block based on the sizes of the encoding blocks for the fourth tile 1222 and the fifth tile 1223, respectively. (Alternatively, the fourth tile 1222 and the fifth tile 1223 may be referred to as not being divided.) The image decoding apparatus 150 may divide the sixth tile 1224 into 16 encoding blocks each having a predetermined size.

According to an embodiment, the image decoding apparatus 150 may determine the size of the encoding block for each frame. The image decoding apparatus 150 may obtain information about the size of the encoding block for the frame from a bitstream. According to an embodiment, the information about the size of the encoding block for the frame may be included in a slice frame of the bitstream. When determining the size of the encoding block for each frame, the image decoding apparatus 150 may determine the size of the tile to be a multiple of the size of the encoding block.

According to an embodiment, the image decoding apparatus 150 may determine the size of the encoding block based on the size of a transform block. The image decoding apparatus 150 may determine the maximum size of the encoding block based on the size of an available maximum transform block. For example, when the size of the available maximum transform block is 16×16, the size of the encoding block may be determined to be 16×16. The image decoding apparatus 150 may determine the minimum size of the encoding block based on the size of an available minimum transform block. For example, when the size of the available maximum transform block is 4×4, the size of the encoding block may be determined to be 8×8.

The image encoding apparatus 100 may determine the size of the encoding block in the same manner as the procedure for determining, by the image decoding apparatus 150, the size of an encoding block, the procedure being described with reference to FIG. 12.

According to an embodiment, the image encoding apparatus 100 may determine the size of an encoding block for a frame. The image encoding apparatus 100 may generate a bitstream including information about the size of the encoding block for the frame. According to an embodiment, the information about the size of the encoding block for the frame may be included in a frame header of the bitstream.

According to an embodiment, the image encoding apparatus 100 may determine the size of an encoding block for a slice. The image encoding apparatus 100 may generate a bitstream including information about the size of the encoding block for the slice. According to an embodiment, the information about the size of the encoding block for the slice may be included in a slice header of the bitstream.

According to an embodiment, the image encoding apparatus 100 may determine the size of an encoding block for a tile. The image encoding apparatus 100 may generate a bitstream including information about the size of the encoding block for the tile. According to an embodiment, the information about the size of the encoding block for the tile may be included in a tile header of the bitstream.

According to an embodiment of the present disclosure, the image decoding apparatus 150 may obtain, from the bitstream, the sizes of blocks (e.g., encoding blocks) into which a current image is divided. The image decoding apparatus 150 may divide an image into a plurality of blocks according to the obtained size of the block.

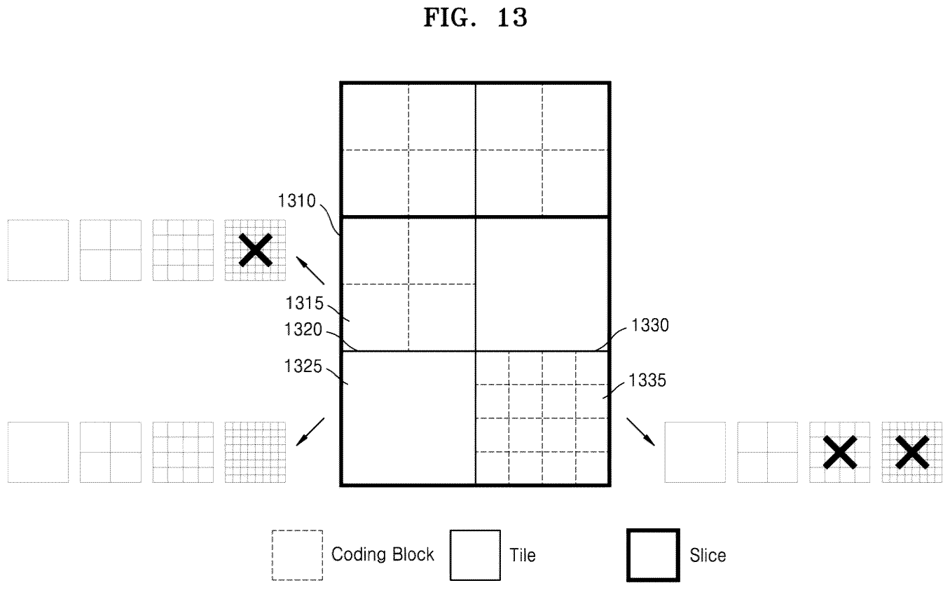

FIG. 13 is a diagram for explaining a process of determining the size of a transform block, according to an embodiment of the present disclosure.

According to an embodiment of the present disclosure, the image decoding apparatus 150 may determine the size of a transform block. For example, the image decoding apparatus 150 may divide a 32×32 encoding block into one of one 32×32 transform block, four 16×16 transform blocks, sixteen 8×8 transform blocks, and 64 4×4 transform blocks. The image decoding apparatus 150 may determine the size of the transform block according to the encoding block. Because the image decoding apparatus 150 is configured to determine the sizes of the transform blocks included in the encoding block to be the same, the complexity of the image decoding apparatus 150 may be reduced. According to an embodiment, the image decoding apparatus 150 may determine the sizes of the transform blocks included in the encoding block by using a recursive procedure.

According to an embodiment, the image decoding apparatus 150 may select one of the sizes of available transform blocks according to the size of the encoding block. For example, the image decoding apparatus 150 may select one of the sizes of the available transform blocks, 16×16 and 8×8, according to a 16×16 encoding block. Alternatively, the sizes of the available transform blocks may be configured to be 16×16, 8×8, and 4×4.

According to an embodiment of the present disclosure, the image decoding apparatus 150 may determine the sizes of transform blocks for each encoding block. For example, the image decoding apparatus 150 may select one of the sizes of available transform blocks, 16×16 and 8×8, for each 16×16 encoding block.

According to an embodiment, the image decoding apparatus 150 may determine the size of a transform block corresponding to the size of the encoding block. For example, the image decoding apparatus 150 may determine the encoding block so as to be divided only into transform blocks each having a predetermined size (e.g., 8×8) according to the size (e.g., 16×16) of the encoding block.

According to an embodiment, the image decoding apparatus 150 may determine the size of a transform block for each frame, slice, or tile. The image decoding apparatus 150 may determine the size of the transform block included in the encoding block differently for each frame, slice, or tile.

According to an embodiment, the image decoding apparatus 150 may determine the size of a transform block for each color component. Because the size of the transform block of the chroma component is determined differently depending on a color format, the image decoding apparatus 150 may determine the size of the transform block of the chroma component depending on the color format. The image decoding apparatus 150 may determine the size of the transform block so that the encoding block of the chroma component is divided into one or more square transform blocks. For example, when the image decoding apparatus 150 determines the size of the transform block for a 16×16 encoding block having a color format of 4:2:2 to be 16×16, the image decoding apparatus 150 may determine the size of the transform block of the luma component to be 16×16 and the size of the transform block of the chroma component to be 8×8. The image decoding apparatus 150 may determine the size of the transform block so that the encoding block of the chroma component is divided into one or more non-square transform blocks. In the above example, the image decoding apparatus 150 may determine the size of the transform block of the chroma component to be 8×16.

In the image decoding apparatus 150, the process of determining the size of the transform block may be replaced with the process of determining the number of transform blocks into which the encoding block is divided. For example, instead of determining that a 16×16 encoding block is divided into 8×8 transform blocks, the image decoding apparatus 150 may determine that a 16×16 encoding block is divided into 4 transform blocks.

Referring to FIG. 13, a first tile 1310 according to an embodiment of the present disclosure is divided into 4 first encoding blocks 1315, a second tile 1320 is determined to be 1 second encoding block 1325, and a third tile 1330 is divided into 16 third encoding blocks 1335. The sizes of the first encoding block 1315, the second encoding block 1325, and the third encoding block 1335 may be 16×16, 32×32, and 8×8, respectively.

According to an embodiment, because the size of the first encoding block 1315 is 32×32, the image decoding apparatus 150 may divide the encoding block into one of 1 32×32 transform block, 4 16×16 transform blocks, 16 8×8 transform blocks, and 64 4×4 transform blocks. Because the size of the second encoding block 1325 is 16×16, the image decoding apparatus 150 may divide the encoding block into one of 1 16×16 transform block, 4 8×8 transform blocks, and 16 4×4 transform blocks. Because the size of the third encoding block 1335 is 8×8, the image decoding apparatus 150 may divide the encoding block into one of 1 8×8 transform block and 4 4×4 transform blocks.

According to an embodiment of the present disclosure, the image decoding apparatus 150 may determine the size of a transform block for a current block (e.g., an encoding block). The image decoding apparatus 150 may divide the current block into a plurality of transform blocks according to a determined size of the transform block.

FIG. 14 is a diagram for explaining a process of predicting a DC transform coefficient, according to an embodiment of the present disclosure.

Referring to FIG. 14, the size of a current transform block 1410 may be 16×16, the size of a first reference transform block 1420 may be 32×32, and the size of a second reference transform block 1430 may be 8×8.

According to an embodiment of the present disclosure, the image decoding apparatus 150 may determine a DC transform coefficient of the current transform block 1410 based on DC transform coefficients of previously predicted transform blocks 1420 and 1430.

The transform coefficient may be determined based on the size of the transform block. When the area of the transform block increases by two times, the value of the transform coefficient increases by \sqrt{2} times. Therefore, when the sizes of the transform blocks are different from each other, the size of the current transform block and the size of the reference transform block may be used to predict the transform coefficient.

According to an embodiment of the present disclosure, the image decoding apparatus 150 may perform prediction by scaling a DC transform coefficient by using a reference block size (e.g., a maximum transform block size). For example, the image decoding apparatus 150 may store a DC transform coefficient “4A (=A*\sqrt{2}^{(log}^{₂}^{(32)+log}^{₂}^{(32))-(log}^{₂}^{(8)+log}^{₂}⁽⁸⁾⁾” obtained by scaling the DC transform coefficient “A” of an 8×8 transform block 1430 to a size of 32×32, and may store a DC transform coefficient “A (=A*\sqrt{2}^{(log}^{₂}^{(32)+log}^{₂}^{(32))-(log}^{₂}^{(32)+log}^{₂}⁽³²⁾⁾” obtained by scaling the DC transform coefficient “A” of a 32×32 transform block 1430 to a size of 32×32. The image decoding apparatus 150 may determine a DC transform coefficient “2A (=A/\sqrt{2}^{(log}^{₂}^{(32)+log}^{₂}^{(32))-(log}^{₂}^{(16)+log}^{₂}⁽¹⁶⁾⁾”, which is obtained by scaling a stored DC transform coefficient 4A based on the 8×8 transform block 1430, as a reference transform coefficient to predict a 16×16 current transform block. The image decoding apparatus 150 may perform prediction by using the reference transform coefficient.

The image decoding apparatus 150 according to an embodiment of the present disclosure may determine a reference DC transform coefficient for prediction of a current transform block based on the width and height of the transform block. For example, the image decoding apparatus 150 may determine the reference DC transform coefficient as in Equation (1).

$$DC pred = DC store / {\sqrt{2}}^{( {log}_{2} ( {W}_{M} ) + {log}_{2} ( {H}_{M} ) ) - ( {log}_{2} ( {W}_{C} ) + {log}_{2} ( {H}_{C} ) )} \qquad ( 1 )$$

Here, W_{M} may represent a maximum transform block width, H_{M} may represent a maximum transform block height, W_{C} may represent a current transform block width, H_{C} may represent a current transform block height, DCstore may represent a stored DC transform coefficient, and DCpred may represent a predicted DC transform coefficient.

The image decoding apparatus 150 according to an embodiment of the present disclosure may determine a DC transform coefficient of the current transform block by using the reference DC transform coefficient. For example, the image decoding apparatus 150 may determine the DC transform coefficient of the current transform block as in Equation (2).

$$DC = DC resi + DC pred \qquad ( 2 )$$

Here, DC may represent the DC transform coefficient of the current transform block, DCresi may represent the residual DC transform coefficient, and DCpred may represent the reference DC transform coefficient.

The image decoding apparatus 150 according to an embodiment of the present disclosure may scale a DC transform coefficient of a predicted current transform block according to the width and height of the transform block and store the scaled DC transform coefficient. For example, the image decoding apparatus 150 may scale a DC transform coefficient as in Equation (3) and store the scaled DC transform coefficient.

$$DC store = DC * {\sqrt{2}}^{( {log}_{2} ( {W}_{M} ) + {log}_{2} ( {H}_{M} ) ) - ( {log}_{2} ( {W}_{C} ) + {log}_{2} ( {H}_{C} ) )} \qquad ( 3 )$$

Here, DCstore may represent a DC transform coefficient to be stored and DC may represent a DC transform coefficient of a predicted current transform block.

According to an embodiment, the sizes of the transform block and the maximum block may both be square. When the size of the transform block is square, the image decoding apparatus 150 may determine a reference DC transform coefficient for predicting the current transform block by using one of the height or width of the transform block. For example, when the transform block is square, Equation (1) may be expressed as Equation (4-1) or Equation (4-2).

$$DC pred = DC store / {2}^{( {log}_{2} ( {W}_{M} ) ) - ( {log}_{2} ( {W}_{C} ) )} \qquad ( 4 - 1 )$$

$$DC pred = DC store >> ( {log}_{2} ( {W}_{M} ) - {log}_{2} ( {W}_{C} ) ) \qquad ( 4 - 2 )$$

When the size of the transform block is square, the DC transform coefficient of the predicted current transform block may be scaled and stored using one of the height or width of the transform block. For example, when the transform block is square, Equation (2) may be expressed as Equation (5-1) or Equation (5-2).

$$DC store = DC * {2}^{( {log}_{2} ( {W}_{M} ) ) - ( {log}_{2} ( {W}_{C} ) )} \qquad ( 5 - 1 )$$

$$DC store = DC << ( {log}_{2} ( {W}_{M} ) - {log}_{2} ( {W}_{C} ) ) \qquad ( 5 - 2 )$$

Because all blocks are square, W_{M} and W_{C} in Equations (4-1), (4-2), (5-1), and (5-2) may be replaced with H_{M} and H_{C}, respectively. “<<” may refer to a left arithmetic shift operation, and “>>” may refer to a right arithmetic shift operation.

The image decoding apparatus 150 according to an embodiment of the present disclosure may store the DC transform coefficient based on the DC transform coefficient of the predicted current transform block and the stored DC transform coefficient. The image decoding apparatus 150 may determine a DC transform coefficient to be stored as a weighted sum of the DC transform coefficient of the predicted current transform block and the stored DC transform coefficient. For example, the image decoding apparatus 150 may store the DC transform coefficient as in Equation (6).

$$DC store = A * DC store + ( 1 - A ) ( DC << ( {log}_{2} ( {W}_{M} ) - {log}_{2} ( {W}_{C} ) ) ) \qquad ( 6 )$$

Here, A is a weight value and may be determined to be a value such as ½, ¼, or ⅛, for example.

According to an embodiment of the present disclosure, the image decoding apparatus 150 may determine a current block among a plurality of blocks divided from a current image. A block according to an embodiment may be an encoding block. The image decoding apparatus 150 may determine a plurality of transform blocks including a first transform block and a second transform block from the current block. According to an embodiment, the first transform block may be a previously predicted block, and the second transform block may refer to a current transform block. The image decoding apparatus 150 may scale a first DC transform coefficient value of the first transform block by using the size of the first transform block and a reference transform size. According to an embodiment, the reference transform size may be the largest size among the sizes of available transform blocks of the image. The image decoding apparatus 150 may obtain a prediction transform coefficient value for the second transform block by using the size of the second transform block and the scaled first DC transform coefficient value. The image decoding apparatus 150 may determine a second DC transform coefficient value of the second transform block by using the prediction transform coefficient value. The image decoding apparatus 150 may perform inverse transform on the second transform block by using the second DC transform coefficient value to restore the current block.

According to an embodiment of the present disclosure, the image decoding apparatus 150 may store the second DC transform coefficient value scaled by using the size of the second transform block and the reference transform size.

According to an embodiment of the present disclosure, the image decoding apparatus 150 may obtain the prediction transform coefficient value by performing a shift operation on the scaled first DC transform coefficient value by using the size of the second transform block and the reference transform size.

According to an embodiment of the present disclosure, the image decoding apparatus 150 may store a value determined by the weighted sum of the first DC transform coefficient value and the scaled second DC transform coefficient value.

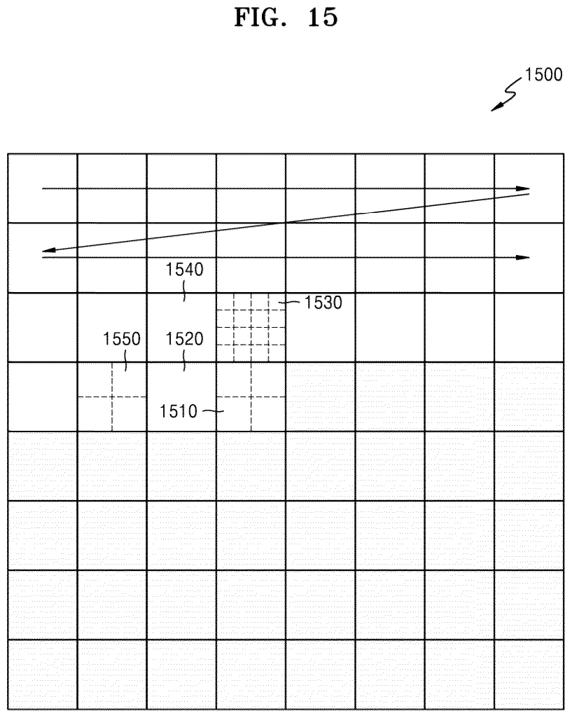

FIG. 15 is a diagram for explaining a process of determining a reference block for predicting a DC transform coefficient, according to an embodiment of the present disclosure.

Referring to FIG. 15, an image 1500 may be predicted in a raster scan order. The image decoding apparatus 150 according to an embodiment of the present disclosure may determine a reference block in order to predict a DC transform coefficient of a current transform block 1510. The image decoding apparatus 150 may predict the DC transform coefficient of the current transform block 1510 based on a DC transform coefficient of a reference block.

According to an embodiment, the image decoding apparatus 150 may determine one of surrounding blocks of the current transform block as the reference block. The image decoding apparatus 150 may determine, as the reference block, one of a first block 1520 adjacent to the left of the current transform block 1510, a second block 1530 adjacent to the upper side of the current transform block 1510, and a third block 1540 adjacent to the upper left side of the current transform block 1510.

The image decoding apparatus 150 may obtain information about the reference block from a bitstream. The information about the reference block may be determined in a direction toward a surrounding block for the current transform block 1510. For example, the information about the reference block may include direction information, such as up, left, and left-up. The image decoding apparatus 150 may determine one of the first block 1520, the second block 1530, and the third block 1540 as the reference block based on the information about the reference block.

According to an embodiment, the image decoding apparatus 150 may determine a plurality of reference blocks from among the surrounding blocks of the current transform block 1510. The image decoding apparatus 150 may perform prediction on the DC transform coefficient of the current transform block 1510 by using an average of DC transform coefficients of the plurality of reference block. For example, the image decoding apparatus 150 may predict the DC transform block of the current transform block 1510 by using the average of the DC transform coefficients of the first block 1520, the second block 1530, and the third block 1540.

According to an embodiment, the image decoding apparatus 150 may determine, as the reference block, one of the blocks predicted before the current transform block 1510. Referring to FIG. 15, one of the blocks on which prediction has been performed before the current transform block 1510 may be determined as the reference block, according to the raster scan order.

The image decoding apparatus 150 may obtain information about the reference block from a bitstream. The information about the reference block may include order information about how many blocks have been predicted before the current transform block. For example, the image decoding apparatus 150 may determine, as the reference block, a fourth block 1550 predicted two blocks before the current transform block, based on the information about the reference block.

According to an embodiment, the image decoding apparatus 150 may determine a plurality of reference blocks among blocks predicted before the current transform block 1510. The image decoding apparatus 150 may perform prediction on the DC transform coefficient of the current transform block 1510 by using the average of the DC transform coefficients of the plurality of reference blocks. For example, the image decoding apparatus 150 may predict the DC transform block of the current transform block 1510 by using an average of DC transform coefficients of the first block 1520 and the fourth block 1550.

According to an embodiment, the image decoding apparatus 150 may determine one reference block for a transform block of a luma component and a transform block of a chroma component. The image decoding apparatus 150 may obtain information about the reference block from a bitstream. According to an embodiment, the information about the reference block may be included in a slice header or a tile header. The image decoding apparatus 150 may determine the reference block before obtaining data for each color component by obtaining information about the reference block from the slice header or the tile header of the bitstream. In an embodiment, the image decoding apparatus 150 may obtain the information about the reference block after segmentation information of the encoding block.

According to an embodiment, the image decoding apparatus 150 may determine different reference blocks for the transform block of the luma component and the transform block of the chroma component. The image decoding apparatus 150 may obtain the information about the reference block from the bitstream. According to an embodiment, the information about the reference block may be included in encoding block data for each color component.

According to an embodiment, the image decoding apparatus 150 may obtain information about a reference block of the second transform block from a bitstream. The image decoding apparatus 150 may determine (e.g., select) the first transform block from among the plurality of transform blocks based on the information about the reference block.

According to an embodiment, the information about the reference block may include index information indicating one of a block adjacent to the second transform block and a block decoded before the second transform block. The image decoding apparatus 150 may determine a block indicated by the index information as the first transform block. For example, the first transform block may be selected by determining a block indicated by the index information as the first transform block.

According to an embodiment of the present disclosure, the image decoding apparatus 150 may determine DC transform coefficient values of a luma block and a chroma block of the second transform block by using the first transform block.

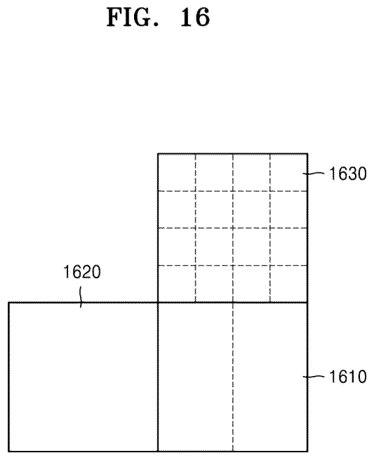

FIG. 16 is a diagram for explaining a process of predicting a DC transform coefficient, according to an embodiment of the present disclosure.

Referring to FIG. 16, a transform block according to an embodiment of the present disclosure may have a non-square shape. The image decoding apparatus 150 may determine a DC transform coefficient of a current transform block 1610 by using the current transform block 1610 having a non-square shape or a reference block.

When all the transform blocks are square, the image decoding apparatus 150 may determine a reference DC transform coefficient or may scale and store the DC transform coefficient, by using one of the width or height of the transform block. For example, when all the transform blocks are square, Equation (1) described above with reference to FIG. 14 may be expressed as Equation (4-1) or (4-2), and Equation (2) may be expressed as Equation (5-1) or (5-2).

When the transform block is non-square, the image decoding apparatus 150 may determine the reference DC transform coefficient or may scale and store the DC transform coefficient, by using the width and height of the transform block.

The image decoding apparatus 150 may determine a shift value based on the width and height of the current transform block 1610 and the width and height of a maximum transform block. For example, the shift value may be determined as in Equation (7).

$$shift = ( ( {log}_{2} ( {W}_{M} ) + {log}_{2} ( {H}_{M} ) ) - ( {log}_{2} ( {W}_{C} ) + {log}_{2} ( {W}_{C} ) ) ) >> 1 \qquad ( 7 )$$

Here, shift may refer to a shift value, W_{M} may refer to a maximum transform block width, H_{M} may refer to a maximum transform block height, W_{C} may refer to a current transform block width, and H_{C} may refer to a current transform block height.

The image decoding apparatus 150 may determine a root flag based on the width and height of the current transform block 1610 and the width and height of the maximum transform block. For example, the root flag may be determined as in Equation (8).

$$is\_root = ( ( {log}_{2} ( {W}_{M} ) + {log}_{2} ( {H}_{M} ) ) - ( {log}_{2} ( {W}_{C} ) + {log}_{2} ( {W}_{C} ) ) ) \qquad ( 8 )$$

The image decoding apparatus 150 may determine a reference DC transform coefficient based on at least one of the shift value and the root flag. The image decoding apparatus 150 may determine the reference DC transform coefficient by using the shift value. The image decoding apparatus 150 may perform an approximation operation of dividing by the square root of 2 based on the root flag. For example, the image decoding apparatus 150 may determine the reference DC transform coefficient through Equations (9) and (10).

$$DC pred = DC store >> shift \qquad ( 9 )$$

$$is\_root == 1 ? ( DC pred * 181 + 128 ) >> 8 : DC pred \qquad ( 10 )$$

(DCpred*181+128)>>8 is an approximation operation of dividing by the square root of 2 according to an embodiment of the present disclosure, but is not limited thereto and may be approximated in various ways depending on effective bits.

The image decoding apparatus 150 may scale and store the DC transform coefficient of the current transform block based on at least one of the shift value and the root flag. The image decoding apparatus 150 may scale and store the DC transform coefficient by using the shift value. The image decoding apparatus 150 may perform an approximation operation of multiplying by the square root of 2 based on the root flag. For example, the image decoding apparatus 150 may scale and store the DC transform coefficient through Equations (11) and (12).

$$DC store = DC << shift \qquad ( 11 )$$

$$is\_root == 1 ? ( DC pred * 181 + 64 ) << 7 : DC pred \qquad ( 12 )$$

(DCpred*181+64)<<7 is an approximate operation of multiplying by the square root of 2 according to an embodiment of the present disclosure, but is not limited thereto and may be approximated in various ways depending on effective bits.

According to an embodiment of the present disclosure, the image decoding apparatus 150 may obtain a prediction transform coefficient value by performing a shift operation on a scaled first DC transform coefficient value by using the size of a second transform block and a reference transform size. When the transform block is non-square, the image decoding apparatus 150 may perform a predetermined operation on the first DC transform coefficient value on which the shift operation has been performed. The predetermined operation may include a multiplication operation, an addition operation, and a shift operation, similar to multiplying by the square root of 2.

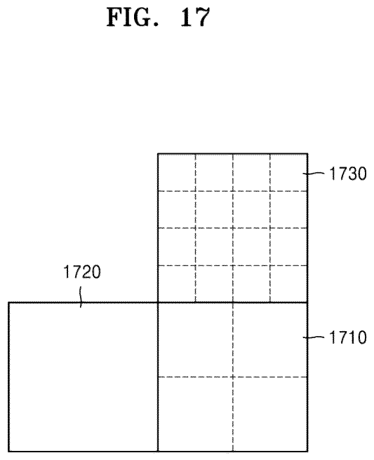

FIG. 17 is a diagram for explaining an entropy encoding method according to an embodiment of the present disclosure.

Referring to FIG. 17, an image may include transform blocks 1710, 1720, and 1730 having different sizes. The image decoding apparatus 150 according to an embodiment of the present disclosure may perform entropy encoding based on the sizes of transform blocks. The image decoding apparatus 150 may perform entropy encoding based on the different sizes of the transform blocks 1710, 1720, and 1730.

Referring to FIGS. 10A and 10B, entropy encoding may be performed on the syntax element (abs_dc_coeff_diff) regarding an absolute value of a residual DC transform coefficient by using a parameter (kParam) used for entropy encoding. The parameter used for entropy encoding may be determined based on a previous residual DC value (PrevDcDiff). According to an embodiment, the parameters used for entropy encoding may be determined based on the previous residual DC value scaled using the size of a transform block.

The image decoding apparatus 150 may scale the previous residual DC value (PrevDcDiff) of the current transform block based on the size of the current transform block. For example, when the size of the current transform block is 8×8 and the size of the maximum transform block is 32×32, the image decoding apparatus 150 may scale the previous residual DC value (PrevDcDiff) of the current transform block by ¼ based on the size 8×8 of the current transform block. The image decoding apparatus 150 may perform entropy decoding on the syntax element regarding the absolute value of the residual DC transform coefficient of the current transform block based on the scaled previous residual DC value (PrevDcDiff).

The image decoding apparatus 150 may scale the absolute value of the residual DC transform coefficient of the current transform block obtained based on entropy decoding and store (or update) the scaled absolute value as the previous residual DC value.

For example, when the size of the current transform block is 8×8 and the size of the maximum transform block is 32×32, the image decoding apparatus 150 may scale the absolute value of the residual DC transform coefficient of the current transform block obtained based on the size 8×8 of the current transform block by 4 times and store (or update) the scaled absolute value.

According to an embodiment, the image decoding apparatus 150 may scale the previous zero-run (PrevRun) in order to perform entropy decoding for the syntax element (coeff_zero_run) regarding zero-run. The image decoding apparatus 150 may scale the value of the zero-run of the current transform block obtained based on the entropy decoding and store (or update) the scaled value as the value of the previous zero-run.

According to an embodiment, the image decoding apparatus 150 may scale the previous level (PrevLevel) to perform entropy decoding on the syntax element (abs_ac_coeff_minus1) regarding the absolute value of the AC transform coefficient. The image decoding apparatus 150 may scale the absolute value of the AC transform coefficient of the current transform block obtained based on the entropy decoding and store (or update) the scaled absolute as the value of the previous level.

According to an embodiment of the present disclosure, the image decoding apparatus 150 may obtain the syntax element regarding the transform coefficient of the second transform block from a bitstream. The image decoding apparatus 150 may determine a parameter for the entropy decoding by using the size of the second transform block. The image decoding apparatus 150 may determine the residual DC transform coefficient value of the second transform block by entropy-decoding the syntax element by using the parameter.

According to an embodiment of the present disclosure, the second DC transform coefficient value may be determined as the sum of the prediction transform coefficient value and the residual DC transform coefficient value.

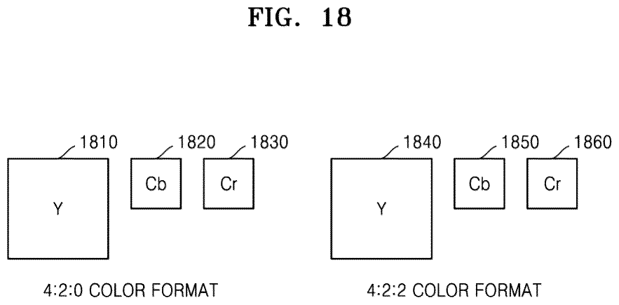

FIG. 18 is a diagram for explaining a process of determining the size of a transform block, according to an embodiment of the present disclosure.

The image decoding apparatus 150 may determine the size of the transform block for each predetermined size. For example, the image decoding apparatus 150 may determine the size of the transform block in units of 32×32 blocks or 16×16 blocks. The predetermined size may be a multiple of the size of the encoding block.

The image decoding apparatus 150 may determine the predetermined size differently for each color component. When the color format of an image is 4:2:0, the image decoding apparatus 150 may determine a predetermined size for a Y component block 1810 to be 2M×2M, a predetermined size for a Cb component block 1820 to be M×M, and a predetermined size for a Cr component block 1830 to be M×M. The image decoding apparatus 150 may determine the size of a transform block for each Y component block 1810 having the predetermined size 2M×2M, and may determine the size of a transform block for each Cb component block 1820 and each Cr component block 1830, which have the predetermined size M×M.

When the color format of the image is 4:2:2, the image decoding apparatus 150 may determine a predetermined size for a Y component block 1840 to be 2M×2M, a predetermined size for a Cb component block 1850 to be M×2M, and a predetermined size for a Cr component block 1860 to be M×2M. The image decoding apparatus 150 may determine the size of a transform block for each Y component block 1840 having the predetermined size 2M×2M, and may determine the size of a transform block for each Cb component block 1850 and each Cr component block 1860, which have the predetermined size M×2M.

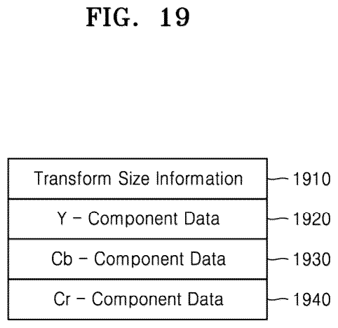

FIG. 19 is a diagram for explaining information about the size of a transform block included in a bitstream according to an embodiment of the present disclosure.

Referring to FIG. 19, a bitstream according to an embodiment of the present disclosure may include information 1910 about the size of a transform block before data 1920, 1930, and 1940 about color components. The information 1910 about the size of the transform block may be determined for each predetermined size of a block.

According to an embodiment, the information 1910 about the size of the transform block may be included in at least one of a frame header, a slice header, or a tile header. The data 1920 for a Y component, the data 1930 for a Cb component, and the data 1940 for a Cr component may be included in tile data for the Y component, tile data for the Cb component, and tile data for the Cr component of the bitstream, respectively. Because the information 1910 about the size of the transform block is included in at least one of the frame header, the slice header, or the tile header, the image decoding apparatus 150 may determine the size of the transform block before obtaining data about the color components. Because information about a transform size is included in the bitstream only once, the amount of data included in the bitstream may be reduced.

According to an embodiment, the information 1910 about the size of the transform block may be included in data about one color component. For example, the information 1910 about the size of the transform block may be included in one of tile data about the Y component, tile data about the Cb component, and tile data about the Cr component. According to an embodiment, the information 1910 about the size of the transform block may have a fixed number of bits depending on the number of sizes of available transform blocks.

According to an embodiment, the image decoding apparatus 150 may determine the size of a transform block for the Y component, the size of a transform block for the Cb component, and the size of a transform block for the Cr component based on the information 1910 about the size of the transform block. The image decoding apparatus 150 may perform decoding (or parsing) by using the determined size of the transform block for the Y component, the determined size of the transform block for the Cb component, and the determined size of the transform block for the Cr component.

According to an embodiment of the present disclosure, the image decoding apparatus 150 may obtain information about the size of a transform block for the current block from at least one of a frame header syntax, a tile header syntax, or a slice header syntax of the bitstream. The image decoding apparatus 150 may obtain information about transform coefficients of a plurality of transform blocks from at least one of a frame data syntax, a tile data syntax, or a slice data syntax for a luma block or a chroma block of the bitstream. The image decoding apparatus 150 may determine a first DC transform coefficient value based on the information about the size of the transform block and the information about the transform coefficient.

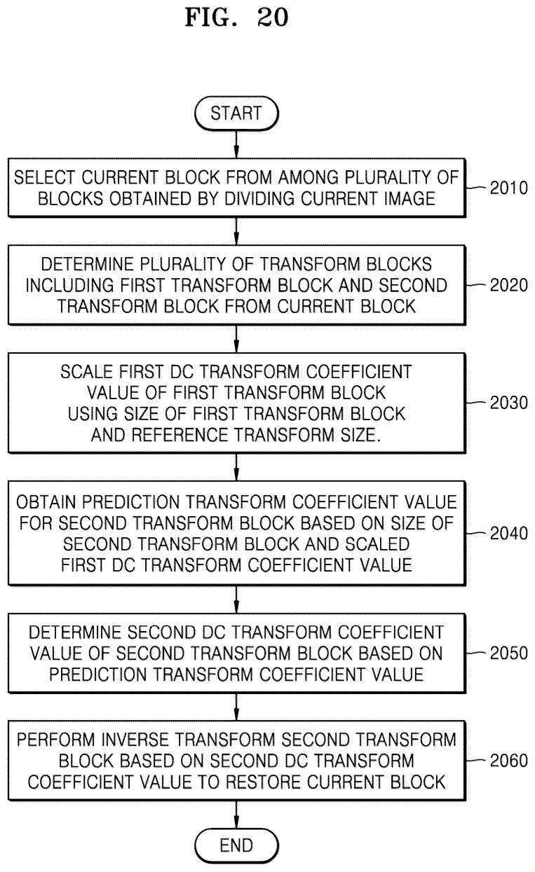

FIG. 20 is a flowchart illustrating an image decoding method according to an embodiment of the present disclosure.

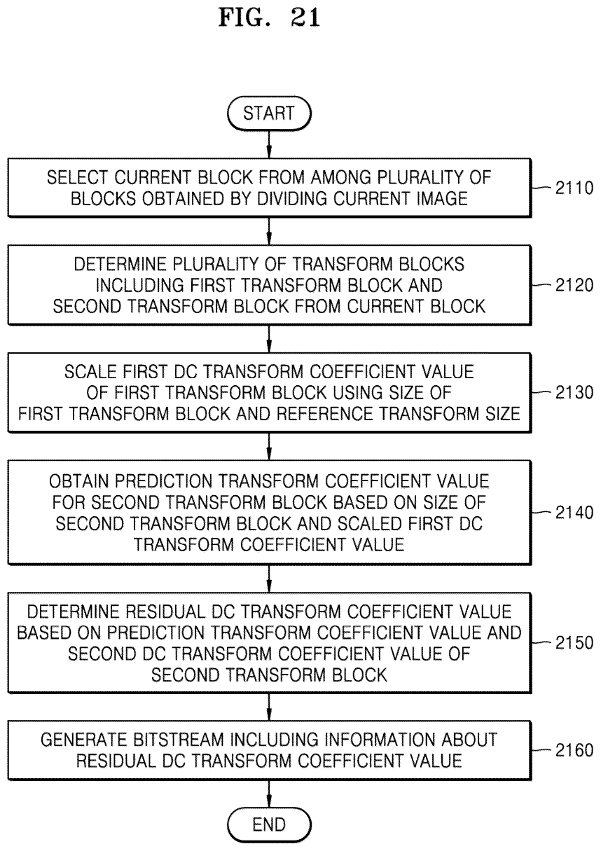

Referring to FIG. 20, an example of an image decoding method according to an embodiment of the present disclosure may include Operations 2010 to 2060. Although FIG. 21 shows an example arrangement of Operations 2010 to 2060, embodiments are not limited thereto, and in some implementations, the image decoding method may include additional Operations, fewer Operations, different Operations, or differently arranged Operations than those depicted in FIG. 20. According to an embodiment, one or more of Operations 2010 to 2060 may be omitted or replaced. Additionally, or alternatively, two or more of Operations 2010 to 2060 may be arranged or combined in any order, or performed in parallel. According to an embodiment, the image decoding method may be performed by the image decoding apparatus 150.

In Operation 2010, the image decoding method may include determining a current block among a plurality of blocks divided from a current image. For example, Operation 2010 may include selecting a current block from among a plurality of blocks obtained by dividing a current image.

In Operation 2020, the image decoding method may include determining a plurality of transform blocks including a first transform block and a second transform block from the current block.

In Operation 2030, the image decoding method may include scaling a first DC transform coefficient value of the first transform block using the size of the first transform block and a reference transform size to obtain a scaled first DC transform coefficient value.

In Operation 2040, the image decoding method may include obtaining a prediction transform coefficient value for the second transform block based on the size of the second transform block and the scaled first DC transform coefficient value.

In Operation 2050, the image decoding method may include determining a second DC transform coefficient value of the second transform block based on the prediction transform coefficient value.

In Operation 2060, the image decoding method may include performing an inverse transform on the second transform block based on the second DC transform coefficient value to restore the current block.

FIG. 21 is a flowchart illustrating an image encoding method according to an embodiment of the present disclosure.

Referring to FIG. 21, an example of an image encoding method according to an embodiment of the present disclosure may include Operations 2110 to 2160. Although FIG. 21 shows an example arrangement of Operations 2110 to 2160, embodiments are not limited thereto, and in some implementations, the image encoding method may include additional Operations, fewer Operations, different Operations, or differently arranged Operations than those depicted in FIG. 21. According to an embodiment, one or more of Operations 2110 to 2160 may be omitted or replaced. Additionally, or alternatively, two or more of Operations 2110 to 2160 may be arranged or combined in any order, or performed in parallel. According to an embodiment, the image encoding method may be performed by the image encoding apparatus 100.

In Operation 2110, the image encoding method may include determining a current block among a plurality of blocks divided from a current image. For example, Operation 2010 may include selecting a current block from among a plurality of blocks obtained by dividing a current image.

In Operation 2120, the image encoding method may include determining a plurality of transform blocks including a first transform block and a second transform block from the current block.

In Operations 2130, the image encoding method may include scaling a first DC transform coefficient value of the first transform block using the size of the first transform block and a reference transform size to obtain a scaled first DC transform coefficient value.

In Operation 2140, the image encoding method may include obtaining a prediction transform coefficient value for the second transform block based on the size of the second transform block and the scaled first DC transform coefficient value.

In Operation 2150, the image encoding method may include determining a residual DC transform coefficient value based on the prediction transform coefficient value and a second DC transform coefficient value of the second transform block.

In Operation 2160, the image encoding method may include generating a bitstream including information about the residual DC transform coefficient value.

The image decoding method and the image encoding method according to an embodiment of the present disclosure may be an image processing method with a relatively small loss and a relatively small error between an original image and a restored image. The image decoding apparatus and the image encoding apparatus according to an embodiment of the present disclosure may be configured with relatively low complexity and may provide a relatively high data throughput.

According to an embodiment of the present disclosure, an image decoding method is provided. The image decoding method may include determining a current block among a plurality of blocks divided from a current image. For example, the image decoding method may include selecting a current block from among a plurality of blocks obtained by dividing a current image. The image decoding method may include a determining a plurality of transform blocks including a first transform block and a second transform block from the current block. The image decoding method may include scaling a first DC transform coefficient value of the first transform block using the size of the first transform block and a reference transform size to obtain a scaled first DC transform coefficient value. The image decoding method may include obtaining a prediction transform coefficient value for the second transform block based on the size of the second transform block and the scaled first DC transform coefficient value. The image decoding method may include determining a second DC transform coefficient value of the second transform block based on the prediction transform coefficient value. The image decoding method may include performing an inverse transform on the second transform block based on the second DC transform coefficient value to restore the current block.

According to an embodiment of the present disclosure, the image decoding method may include scaling the second DC transform coefficient value using the size of the second transform block and the reference transform size to obtain a scaled second DC transform coefficient value, and storing the scaled second DC transform coefficient value.

According to an embodiment of the present disclosure, the image decoding method may include obtaining, from a bitstream, sizes of the plurality of blocks into which the current image is divided. The image decoding method may include dividing the current image into the plurality of blocks according to the obtained sizes of the plurality of blocks.

According to an embodiment of the present disclosure, the image decoding method may include determining the size of a transform block for the current block. The image decoding method may include dividing the current block into the plurality of transform blocks according to the determined size of the transform block.

According to an embodiment of the present disclosure, the obtaining of the prediction transform coefficient value may include obtaining the prediction transform coefficient value by performing a shift operation on the scaled first DC transform coefficient value using the size of the second transform block and the reference transform size. For example, the prediction transform coefficient value may be obtained by shifting the scaled first DC transform coefficient value using the size of the second transform block and the reference transform size to obtain a shifted first DC transform coefficient value.

According to an embodiment of the present disclosure, the obtaining of the prediction transform coefficient value by performing the shift operation may include performing, when the transform block is non-square (e.g., based on the transform block being non-square), a predetermined operation on the first DC transform coefficient value on which the shift operation has been performed. The predetermined operation may include a multiplication operation, an addition operation, and a shift operation. According to embodiments, the predetermined operation may be similar to (e.g., approximately equivalent to) multiplying by a square root of 2.

According to an embodiment of the present disclosure, the image decoding method may include obtaining information about a reference block of the second transform block from a bitstream. The image decoding method may include determining (e.g., selecting) the first transform block from among the plurality of transform blocks based on the information about the reference block.

According to an embodiment of the present disclosure, the information about the reference block may include index information indicating one from among a block adjacent to the second transform block and a block decoded before the second transform block. The determining of the first transform block may include determining a block indicated by the index information as the first transform block. For example, the first transform block may be selected by determining a block indicated by the index information as the first transform block.

According to an embodiment of the present disclosure, the image decoding method may include determining DC transform coefficient values of a luma block and a chroma block of the second transform block based on the first transform block.

According to an embodiment of the present disclosure, the storing of the second DC transform coefficient value may include storing a value determined based on a weighted sum of the first DC transform coefficient value and the scaled second DC transform coefficient value.

According to an embodiment of the present disclosure, the image decoding method may include obtaining a syntax element related to a transform coefficient of the second transform block from a bitstream. The image decoding method may include determining a parameter for entropy decoding based on the size of the second transform block. The image decoding method may include determining a residual DC transform coefficient value of the second transform block by entropy-decoding the syntax element by using the parameter.

According to an embodiment of the present disclosure, the second DC transform coefficient value may be determined to be (e.g., may include) a sum of the prediction transform coefficient value and the residual DC transform coefficient value.

According to an embodiment of the present disclosure, the image decoding method may include obtaining information about the size of a transform block for the current block from at least one of a frame header syntax, a tile header syntax, or a slice header syntax of a bitstream. The image decoding method may include obtaining information about transform coefficients of the plurality of transform blocks from at least one of a frame data syntax, a tile data syntax, or a slice data syntax for a luma block or a chroma block of the bitstream. The image decoding method may include determining the first DC transform coefficient value based on the information about the size of the transform block and the information about the transform coefficients.

According to an embodiment of the present disclosure, an image decoding apparatus is provided. The image decoding apparatus may include at least one processor, and memory. The memory may store one or more instructions which, when executed by the at least one processor, cause the image decoding apparatus to determine a current block among a plurality of blocks divided from a current image. For example, the image decoding apparatus may select a current block from among a plurality of blocks obtained by dividing a current image. The image decoding apparatus may determine a plurality of transform blocks including a first transform block and a second transform block from the current block. The image decoding apparatus may scale a first DC transform coefficient value of the first transform block by using the size of the first transform block and a reference transform size to obtain a scaled first DC transform coefficient value. The image decoding apparatus may obtain a prediction transform coefficient value for the second transform block based on the size of the second transform block and the scaled first DC transform coefficient value. The image decoding apparatus may determine a second DC transform coefficient value of the second transform block based on the prediction transform coefficient value. The image decoding apparatus may perform inverse transform on the second transform block based on the second DC transform coefficient value to restore the current block. According to an embodiment of the present disclosure, there may be various effects including an effect of being able to compress an image with low complexity.

According to an embodiment of the present disclosure, the image decoding apparatus may scale the second DC transform coefficient value using the size of the second transform block and the reference transform size to obtain a scaled second DC transform, and may store the scaled second DC transform coefficient value. According to an embodiment of the present disclosure, there may be various effects including an effect of being able to compress an image with low complexity.

According to an embodiment of the present disclosure, the image decoding apparatus may obtain, from a bitstream, the sizes of the plurality of blocks into which the current image is divided. The image decoding apparatus may divide the current image into the plurality of blocks according to the obtained sizes of the plurality of blocks. According to an embodiment of the present disclosure, there may be various effects including an effect of being able to efficiently predict an image.

According to an embodiment of the present disclosure, the image decoding apparatus may determine the size of a transform block for the current block. The image decoding apparatus may divide the current block into the plurality of transform blocks according to the determined size of the transform block. According to an embodiment of the present disclosure, there may be various effects including an effect of being able to efficiently predict an image.

According to an embodiment of the present disclosure, the image decoding apparatus may obtain the prediction transform coefficient value by performing a shift operation on the scaled first DC transform coefficient value using the size of the second transform block and the reference transform size. For example, the prediction transform coefficient value may be obtained by shifting the scaled first DC transform coefficient value using the size of the second transform block and the reference transform size to obtain a shifted first DC transform coefficient value. According to an embodiment of the present disclosure, there may be various effects including an effect of being able to compress an image with low complexity.

According to an embodiment of the present disclosure, the image decoding apparatus may perform, when the transform block is non-square, a predetermined operation on the first DC transform coefficient value on which the shift operation has been performed. The predetermined operation may include a multiplication operation, an addition operation, and a shift operation. According to embodiments, the predetermined operation may be similar to (e.g., approximately equivalent to) multiplying by a square root of 2. According to an embodiment of the present disclosure, there may be various effects including an effect of being able to compress an image with low complexity.

According to an embodiment of the present disclosure, the image decoding apparatus may obtain information about a reference block of the second transform block from a bitstream. The image decoding apparatus may determine (e.g., select) the first transform block from among the plurality of transform blocks based on the information about the reference block. According to an embodiment of the present disclosure, there may be various effects including an effect of being able to compress an image with low complexity.

According to an embodiment of the present disclosure, the information about the reference block may include index information indicating one of a block adjacent to the second transform block and a block decoded before the second transform block. The image decoding apparatus may determine a block indicated by the index information as the first transform block. For example, the first transform block may be selected by determining a block indicated by the index information to be the first transform block. According to an embodiment of the present disclosure, there may be various effects including an effect of being able to compress an image with low complexity.

According to an embodiment of the present disclosure, the image decoding apparatus may determine DC transform coefficient values of a luma block and a chroma block of the second transform block based on the first transform block.

According to an embodiment of the present disclosure, the image decoding apparatus may store a value determined by a weighted sum of the first DC transform coefficient value and the scaled second DC transform coefficient value. According to an embodiment of the present disclosure, there may be various effects including an effect of being able to efficiently predict an image.

According to an embodiment of the present disclosure, the image decoding apparatus may obtain a syntax element related to a transform coefficient of the second transform block from a bitstream. The image decoding apparatus may determine a parameter for entropy decoding based on the size of the second transform block. The image decoding apparatus may determine a residual DC transform coefficient value of the second transform block by entropy-decoding the syntax element based on the parameter. According to an embodiment of the present disclosure, there may be various effects including an effect of being able to compress an image with low complexity.

According to an embodiment of the present disclosure, the second DC transform coefficient value may be determined as (e.g., may include) a sum of the prediction transform coefficient value and the residual DC transform coefficient value. According to an embodiment of the present disclosure, there may be various effects including an effect of being able to compress an image with low complexity.

According to an embodiment of the present disclosure, the image decoding apparatus may obtain information about the size of a transform block for the current block from at least one of a frame header syntax, a tile header syntax, or a slice header syntax of a bitstream. The image decoding apparatus may obtain information about transform coefficients of the plurality of transform blocks from at least one of a frame data syntax, a tile data syntax, or a slice data syntax for a luma block or a chroma block of the bitstream. The image decoding apparatus may determine the first DC transform coefficient value based on the information about the size of the transform block and the information about the transform coefficients. According to an embodiment of the present disclosure, there may be various effects including an effect of being able to compress an image with low complexity.

According to an embodiment of the present disclosure, an image encoding method is provided. The image encoding method may include determining a current block among a plurality of blocks into which a current image is divided. For example, the image encoding method may include selecting a current block from among a plurality of blocks obtained by dividing a current image. The image encoding method may include determining a plurality of transform blocks including a first transform block and a second transform block from the current block. The image encoding method may include scaling a first DC transform coefficient value of the first transform block based on the size of the first transform block and a reference transform size to obtain a scaled first DC transform coefficient value. The image encoding method may include obtaining a prediction transform coefficient value for the second transform block based on the size of the second transform block and the scaled first DC transform coefficient value. The image encoding method may include determining a residual DC transform coefficient value based on the prediction transform coefficient value and a second DC transform coefficient value of the second transform block. The image encoding method may include generating a bitstream including information about the residual DC transform coefficient value.

According to an embodiment of the present disclosure, the image encoding method may include storing scaling the second DC transform coefficient value using the size of the second transform block and the reference transform size to obtain a scaled second DC transform, and storing the scaled second DC transform coefficient value.

According to an embodiment of the present disclosure, the image encoding method may include determining sizes of blocks divided from the current image. The image encoding method may include dividing the image into the plurality of blocks according to the determined sizes of the blocks. The bitstream may include information about the sizes of the blocks into which the current image is divided.

According to an embodiment of the present disclosure, the image encoding method may include determining the size of a transform block for the current block. The image encoding method may include dividing the current block into the plurality of transform blocks according to the determined size of the transform block.

According to an embodiment of the present disclosure, the obtaining of the prediction transform coefficient value may include obtaining the prediction transform coefficient value by performing a shift operation on the scaled first DC transform coefficient value based on the size of the second transform block and the reference transform size. For example, the prediction transform coefficient value may be obtained by shifting the scaled first DC transform coefficient value using the size of the second transform block and the reference transform size to obtain a shifted first DC transform coefficient value.

According to an embodiment of the present disclosure, the obtaining of the prediction transform coefficient value by performing the shift operation may include performing, when the transform block is non-square, a predetermined operation on the first DC transform coefficient value on which the shift operation has been performed. The predetermined operation may include a multiplication operation, an addition operation, and a shift operation. According to embodiments, the predetermined operation may be similar to (e.g., approximately equivalent to) multiplying by a square root of 2.

According to an embodiment of the present disclosure, the image encoding method may include determining information about a reference block of the second transform block. The image decoding method may include determining (e.g., selecting) the first transform block from among the plurality of transform blocks based on the information about the reference block. The bitstream may include the information about the reference block of the second transform block.

According to an embodiment of the present disclosure, the information about the reference block may include index information indicating one of a block adjacent to the second transform block and a block decoded before the second transform block. The determining of the first transform block may include determining a block indicated by the index information as the first transform block. For example, the first transform block may be selected by determining a block indicated by the index information to be the first transform block.

According to an embodiment of the present disclosure, the image encoding method may include determining DC transform coefficient values of a luma block and a chroma block of the second transform block based on the first transform block.

According to an embodiment of the present disclosure, the storing of the second DC transform coefficient value may include storing a value determined by a weighted sum of the first DC transform coefficient value and the scaled second DC transform coefficient value.

According to an embodiment of the present disclosure, the image encoding method may include determining a parameter for entropy encoding based on the size of the second transform block. The image encoding method may include determining a syntax element regarding a transform coefficient of the second transform block by entropy-encoding the value of a transform coefficient of the second transform block based on the parameter. The bitstream may include the syntax element.

According to an embodiment of the present disclosure, the second DC transform coefficient value may be determined to be (e.g., may include) a sum of the prediction transform coefficient value and the residual DC transform coefficient value.

According to an embodiment of the present disclosure, the image encoding method may include determining information about the size of a transform block for the current block. The image encoding method may include determining information about transform coefficients of the plurality of transform blocks. The image encoding method may include determining the first DC transform coefficient value based on the information about the size of the transform block and the information about the transform coefficients. The bitstream may include the information about the size of the transform block in at least one of a frame header syntax, a tile header syntax, or a slice header syntax, and may include the information about the transform coefficients in at least one of a frame data syntax, a tile data syntax, or a slice data syntax for a luma block or a chroma block.

According to an embodiment of the present disclosure, an image encoding apparatus is provided. The image encoding apparatus may include at least one processor, and memory. The memory may store one or more instructions which, when executed by the at least one processor, cause the image encoding apparatus to determine a current block among a plurality of blocks divided from a current image. For example, the image encoding apparatus may select a current block from among a plurality of blocks obtained by dividing a current image. The image encoding apparatus may determine a plurality of transform blocks including a first transform block and a second transform block from the current block. The image encoding apparatus may scale a first DC transform coefficient value of the first transform block based on the size of the first transform block and a reference transform size to obtain a scaled first DC transform coefficient value. The image encoding apparatus may obtain a prediction transform coefficient value for the second transform block based on the size of the second transform block and the scaled first DC transform coefficient value. The image encoding apparatus may determine a residual DC transform coefficient value based on the prediction transform coefficient value and a second DC transform coefficient value of the second transform block. The image encoding apparatus may generate a bitstream including information about the residual DC transform coefficient value.

The technical goal to be achieved in the present disclosure is not limited to the technical goal mentioned above, and other technical goals not mentioned may be clearly understood by one of ordinary skill in the art, to which the present disclosure belongs, from the description below.

The effects that may be obtained in the present disclosure are not limited to the effects mentioned above, and other effects not mentioned may be clearly understood by one of ordinary skill in the art, to which the present disclosure belongs, from the description above.

A device-readable storage medium may be provided in the form of a non-transitory storage medium. In this regard, the “non-transitory storage medium” simply means that the storage medium is a tangible apparatus and does not include a signal (e.g., an electromagnetic wave), but this term does not differentiate between where data is semi-permanently stored in the storage medium and where the data is temporarily stored in the storage medium. For example, the “non-transitory storage medium” may include a buffer in which data is temporarily stored.

According to an embodiment, the method according to various embodiments may be included and provided in a computer program product. The computer program product may be traded as a product between a seller and a buyer. The computer program product may be distributed in the form of a machine-readable storage medium (e.g., a CD-ROM), or distributed (e.g., downloaded or uploaded) through an application store, or directly or online between two user apparatuses (e.g., smart phones). In the case of online distribution, at least a portion of a computer program product (e.g., a downloadable application) may be temporarily stored in a machine-readable storage medium, such as memory of a manufacturer's server, an application store's server, or a relay server, or may be temporarily generated.

What is claimed is:

1. An image decoding method comprising:
selecting a current block from among a plurality of blocks obtained by dividing a current image;
determining a plurality of transform blocks comprising a first transform block and a second transform block based on the current block;
scaling a first direct current (DC) transform coefficient value of the first transform block using a size of the first transform block and a reference transform size to obtain a scaled first DC transform coefficient value;
obtaining a prediction transform coefficient value for the second transform block based on a size of the second transform block and the scaled first DC transform coefficient value;
determining a second DC transform coefficient value of the second transform block based on the prediction transform coefficient value; and
restoring the current block by performing an inverse transform on the second transform block based on the second DC transform coefficient value.

2. The image decoding method of claim 1, further comprising:
scaling the second DC transform coefficient value using the size of the second transform block and the reference transform size to obtain a scaled second DC transform coefficient value; and
storing the scaled second DC transform coefficient value.

3. The image decoding method of any claim 1, further comprising:
obtaining, from a bitstream, sizes the plurality of blocks; and
dividing the current image into the plurality of blocks according to the sizes.

4. The image decoding method of claim 1, further comprising:
determining a size of a transform block for the current block; and
dividing the current block into the plurality of transform blocks according to the size.

5. The image decoding method of claim 1, wherein the prediction transform coefficient value is obtained by shifting the scaled first DC transform coefficient value using the size of the second transform block and the reference transform size to obtain a shifted first DC transform coefficient value.

6. The image decoding method of claim 5, wherein based on the transform block being non-square, the prediction transform coefficient value is obtained by performing a predetermined operation on the shifted first DC transform coefficient value,
wherein the predetermined operation comprises a multiplication operation, an addition operation, and a shift operation.

7. The image decoding method of claim 1, further comprising:
obtaining information about a reference block of the second transform block from a bitstream; and
selecting the first transform block from among the plurality of transform blocks based on the information about the reference block.

8. The image decoding method of claim 7, wherein the information about the reference block comprises index information indicating one from among a block adjacent to the second transform block, and a block decoded before the second transform block,
wherein the first transform block is selected by determining a block indicated by the index information as the first transform block.

9. The image decoding method of claim 7, further comprising:
determining DC transform coefficient values of a luma block and a chroma block of the second transform block based on the first transform block.

10. The image decoding method of claim 2, wherein the storing of the second DC transform coefficient value comprises:
storing a value determined based on a weighted sum of the first DC transform coefficient value and the scaled second DC transform coefficient value.

11. The image decoding method of claim 1, further comprising:
obtaining a syntax element related to a transform coefficient of the second transform block from a bitstream;
determining a parameter for entropy decoding based on the size of the second transform block; and
determining a residual DC transform coefficient value of the second transform block by entropy-decoding the syntax element based on the parameter.

12. The image decoding method of claim 11, wherein the second DC transform coefficient value comprises a sum of the prediction transform coefficient value and the residual DC transform coefficient value.

13. The image decoding method of any claim 1, further comprising:
obtaining information about a size of a transform block for the current block from at least one of a frame header syntax, a tile header syntax, or a slice header syntax of a bitstream;
obtaining information about transform coefficients of the plurality of transform blocks from at least one of a frame data syntax, a tile data syntax, or a slice data syntax for a luma block or a chroma block of the bitstream; and
determining the first DC transform coefficient value based on the information about the size of the transform block and the information about the transform coefficients.

14. A image decoding apparatus comprising:
at least one processor; and
a memory storing one or more instructions which, when executed by the at least one processor, cause the image decoding apparatus to:
select a current block from among a plurality of blocks obtained by dividing a current image,
determine a plurality of transform blocks comprising a first transform block and a second transform block based on the current block,
scale a first direct current (DC) transform coefficient value of the first transform block using a size of the first transform block and a reference transform size to obtain a scaled first DC transform coefficient value,
obtain a prediction transform coefficient value for the second transform block based on a size of the second transform block and the scaled first DC transform coefficient value,
determine a second DC transform coefficient value of the second transform block based on the prediction transform coefficient value, and
restore the current block by performing an inverse transform on the second transform block based on the second DC transform coefficient value.

15. An image encoding method comprising:
selecting a current block from among a plurality of blocks obtained by dividing a current image;
determining a plurality of transform blocks comprising a first transform block and a second transform block from the current block;
scaling a first direct current (DC) transform coefficient value of the first transform block using a size of the first transform block and a reference transform size to obtain a scaled first DC transform coefficient value;
obtaining a prediction transform coefficient value for the second transform block based on a size of the second transform block and the scaled first DC transform coefficient value;
determining a residual DC transform coefficient value based on the prediction transform coefficient value and a second DC transform coefficient value of the second transform block; and
generating a bitstream comprising information about the residual DC transform coefficient value.
